(19) United States
(12) Patent Application Publication
(10) Pub. No.: US 2026/0029771 A1
(43) Pub. Date: Jan. 29, 2026

(54) PROGRAMMABLE LOGIC CONTROLLER, SUPPORT DEVICE, AND DISPLAY DEVICE

(71) Applicant: FUJI ELECTRIC CO., LTD., Kawasaki-shi (JP)

(72) Inventor: Ryosuke NAKANO, Kawasaki-shi (JP)

(73) Assignee: FUJI ELECTRIC CO., LTD., Kawasaki-shi (JP)

(21) Appl. No.: 19/223,972

(22) Filed: May 30, 2025

(30) Foreign Application Priority Data
Jul. 29, 2024 (JP) 2024-121821

(51) Int. Cl. G05B 19/05

(52) U.S. Cl. CPC G05B 19/058; G05B 2219/14055

(57) ABSTRACT

A programmable logic controller for controlling an external apparatus, including: an execution unit configured to repeatedly execute a control processing cycle, by executing a control program for controlling the external apparatus, the control program including a variable, outputting an execution result of the control program, and collecting variable data related to the variable in the control program according to a logging configuration; a memory that includes first and second memory areas respectively for storing actual input data and control information related to forcible setting; and a storage unit that stores the collected variable data. The execution unit is configured to generate input data to be given to the variable based on the actual input data and the control information, and store the actual input data and the control information in the storage unit in association with a time at which the variable data is collected in the logging process.

### CROSS-REFERENCE TO RELATED APPLICATIONS

This application is based upon and claims the benefit of priority to Japanese Patent Application No. 2024-121821, filed on Jul. 29, 2024, the entire contents of which are incorporated herein by reference.

### BACKGROUND OF THE INVENTION

### 1. Technical Field

The present invention relates to a programmable logic controller, a support device that supports the programmable logic controller, and a display device that displays information acquired from the programmable logic controller.

### 2. Description of the Related Art

A programmable logic controller (PLC) executes an application program such as a ladder program in factory automation to control a manufacturing apparatus, a conveyance device, an inspection device, or the like. Here, there is a demand for recording logs related to control of various apparatuses or devices and referring to the logs as necessary. Therefore, there is proposed a technique that enables logging without affecting the control of various apparatuses or devices has been proposed (for example, Patent document 1).
Patent document 1: JP Patent 7188631

### SUMMARY OF THE INVENTION

When a failure of an instrument or the like occurs during operation of a system to which the PLC is applied, a normal value may not be set. In order to continue the operation of the system in such a situation, a procedure of forcibly setting a predetermined value in the PLC instead of a value obtained from the failed instrument is considered to be effective. However, in the technique according to the related art (for example, the technique described in Patent document 1), it may not be possible to identify whether a value collected by the logging from the PLC is the value output from the instrument or the predetermined value forcibly set. Therefore, in the technique according to the related art, a user of the PLC may not be able to recognize a situation in which the predetermined value is forcibly set in the PLC due to the failure of the instrument or the like.

An object according to one aspect of the present invention is to enable identification of whether a value collected by logging from a PLC is a value output from an instrument or a predetermined value forcibly set in a system in which the predetermined value can be forcibly set in the PLC.

A programmable logic controller according to one aspect of the present invention includes an execution unit, a memory, and a storage unit. The execution unit repeatedly executes a control processing cycle including a program execution process of executing a control program, an output process of outputting an execution result of the control program to control an external apparatus, and a logging process of collecting variable data related to a variable used in the control program according to a logging configuration. The memory includes a first memory area that stores actual input data to be given to the variable, and a second memory area that stores control information related to forcible setting for giving predetermined forcible setting input data to the variable instead of the actual input data. The storage unit stores the data collected by the logging process.

The execution unit generates input data to be given to the variable based on the actual input data and the control information, and stores the actual input data and the control information in the storage unit in association with the time information indicating the time at which the variable data is collected in the logging process.

A support device according to one aspect of the present invention includes a setting information output unit that generates and outputs the logging configuration including information indicating that the actual input data stored in the first memory area and the control information stored in the second memory area are collected in the logging process in order to support the above-described programmable logic controller.

A display device according to one aspect of the present invention includes a reading unit, an analysis unit, and a display unit in order to display the data collected by the above-described programmable logic controller. The reading unit reads collected logging data from the storage device. The analysis unit determines whether or not the forcible setting has been performed for the variable based on the control information. The display unit displays a value represented by the actual input data when the forcible setting has not been performed for the variable, and displays a value represented by the forcible setting input data when the forcible setting has been performed for the variable.

According to the above aspect, it is possible to identify whether the value collected by the logging from the PLC is the value output from the instrument or the predetermined value forcibly set in the system in which the predetermined value can be forcibly set in the PLC.

### BRIEF DESCRIPTION OF THE DRAWINGS

FIG. 1 is a diagram illustrating a configuration example of a programmable logic controller (PLC) system;

FIG. 2 is a diagram illustrating an example of control processing executed by a PLC;

FIG. 3 is a diagram illustrating an example of a hardware configuration of the PLC;

FIG. 4 is a diagram illustrating an example of a hardware configuration of a personal computer (PC);

FIG. 5 is a diagram illustrating an example of a functional configuration of a support device;

FIG. 6 is a diagram illustrating an example of a method for creating a logging configuration;

FIG. 7 is a diagram illustrating an example of a user interface (UI) screen used in collection target setting process;

FIG. 8 is a diagram illustrating an example of logging configuration data;

FIG. 9 is a diagram illustrating an example of collection target setting information;

FIG. 10 is a diagram illustrating an example of a correspondence between a memory address of a variable used on project data and a memory area on a memory of the PLC;

FIG. 11 is a diagram illustrating an example of a functional configuration of the PLC;

FIG. 12 is a diagram illustrating an example of logging process executed by the PLC;

FIG. 13 is a flowchart illustrating an example of the logging process and storing process;

FIG. 14 is a diagram illustrating an example of a data structure of collected logging data;

FIGS. 15A and 15B are diagrams illustrating an example of data structures of sampled data and variable data;

FIGS. 16A and 16B are diagrams illustrating examples of forcible setting performed in the PLC system;

FIG. 17 is a flowchart illustrating an example of collection process;

FIG. 18 is a diagram illustrating an example of a functional configuration related to forcible setting of the variable;

FIG. 19 is a diagram illustrating an example of input data generation process;

FIG. 20 is a diagram illustrating an example of output data transfer process;

FIGS. 21A, 21B and 22 are diagrams illustrating examples of forcible setting and logging process related to input data;

FIGS. 23A, 23B and 24 are diagrams illustrating examples of forcible setting and logging process related to output data;

FIG. 25 is a diagram illustrating an example of a hardware configuration of a collected data display device;

FIG. 26 is a diagram illustrating an example of a functional configuration of the collected data display device;

FIG. 27 is a diagram illustrating an example of a method for displaying the collected logging data;

FIG. 28 is a diagram illustrating an example of program display process;

FIG. 29 is a view illustrating an example of a sampled data display screen;

FIG. 30 is a view illustrating an example of a warning screen displayed on a display device;

FIG. 31 is a diagram illustrating an example of waveform display process;

FIG. 32 is a view illustrating an example of a waveform display screen for the sampled data;

FIG. 33 is a diagram illustrating an example of logging file analysis/conversion process;

FIG. 34 is a flowchart illustrating an example of the logging file analysis/conversion process;

FIG. 35 is a flowchart illustrating an example of process of creating display data of each target variable;

FIG. 36 is a diagram illustrating an example of display control process;

FIG. 37 is a view illustrating an example of highlighting the target variable for which the forcible setting has been performed on a user program display screen; and

FIG. 38 is a view illustrating an example of highlighting the target variable for which the forcible setting has been performed on the waveform display screen.

### DETAILED DESCRIPTION

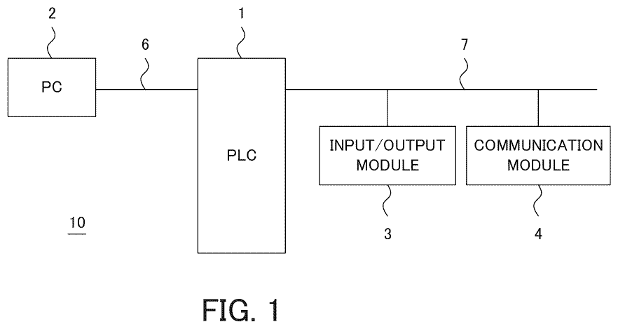

FIG. 1 illustrates a configuration example of a programmable logic controller (PLC) system 10. The PLC system 10 illustrated in FIG. 1 includes a PLC 1, a personal computer (PC) 2, an input/output module 3, and a communication module 4. The PLC 1 and the PC 2 are connected via a communication cable 6. The PLC 1 controls, for example, various apparatuses or devices installed in a factory in factory automation.

The PC 2 provides a function as a support device that supports the PLC 1. The PC 2 also provides a function of setting a condition for executing a logging process in the PLC 1. The PC 2 can edit a user application program used by the PLC 1. The user application program is an example of a control program for controlling an external apparatus. In the following description, the user application program may be referred to as a “user program” or “control program”.

The user program is created using, for example, a ladder language compliant with International Electrotechnical Commission (IEC) 61131-3. In addition, the user program may be created using a graphical programming language such as a flowchart-format motion program such as a sequential function chart (SFC). Alternatively, the user program may be created using a high-level programming language such as C language.

As described below, the PC 2 has the function of setting the condition for executing the logging process. As described below, the PC 2 may have a function of starting/canceling forcible setting of forcibly setting a value of a variable used by the PLC 1.

The PLC 1, the input/output module 3, and the communication module 4 are connected via a communication bus 7. A plurality of input/output modules 3 and/or a plurality of communication modules 4 may be connected to the communication bus 7. The input/output module 3 and the communication module 4 are preferably attachable to and detachable from the PLC system 10. The input/output module 3 and the communication module 4 correspond to external apparatuses.

The input/output module 3 inputs/outputs a digital signal or an analog signal. In addition, the input/output module 3 may have a function of converting a signal of a servo amplifier, an encoder, or a sensor into an electric signal. The communication module 4 provides an interface for communication with other apparatuses.

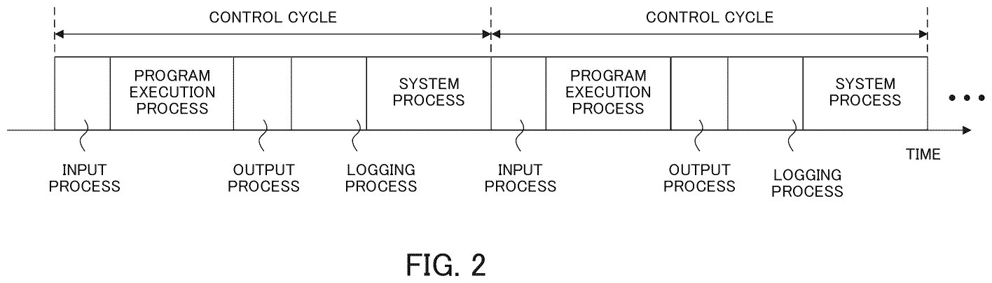

FIG. 2 illustrates an example of control processing executed by the PLC 1. As illustrated in FIG. 2, the PLC 1 repeatedly executes a control processing cycle including an input process, a program execution process, an output process, the logging process, and a system process in each control cycle.

The input process obtains input data received from the input/output module 3. The program execution process executes the user program created by a user. The input data obtained by the input process is used in the execution of the user program. The output process outputs a result of the execution of the user program to control the input/output module 3. That is, the result of the execution of the user program is reflected in an output of the input/output module 3.

The logging process collects data representing values of variables used in the user program to generate collected logging data. In addition, in the logging process, data representing an operation state of each constituent apparatus of the PLC system 10 including the PLC 1 is recorded and stored as a history.

The system process manages operation of the PLC 1 to maintain the proper operation of the PLC 1. In addition, the system process includes process of writing the user program and logging configuration data in a memory in the PLC 1. Furthermore, the system process may include forcible setting control process described below.

The PLC 1 executes the logging process after the output process in each control cycle so as not to hinder the execution of the user program. The control cycle is a sum of execution periods of the input process, the program execution process, the output process, the logging process, and the system process. Therefore, once the control cycle is designated, the execution period of the logging process is limited by a bandwidth allocated to the control cycle. The control cycle is designated by the user, for example. A bandwidth of the logging process may be adjustable by changing ratios of the execution periods allocated to the program execution process, the logging process, and the system process.

Here, in a case where a target apparatus controlled by the PLC 1 fails, an abnormal value may be stored in a memory area for a variable corresponding to a failed instrument. In this case, the use of the value of the memory area may adversely affect a control operation. Therefore, the PLC 1 has a function of continuing a system operation while forcibly rewriting the value of the variable (that is, data stored in the corresponding memory area) to a predetermined value. Such a function is provided, for example, in the system process illustrated in FIG. 2.

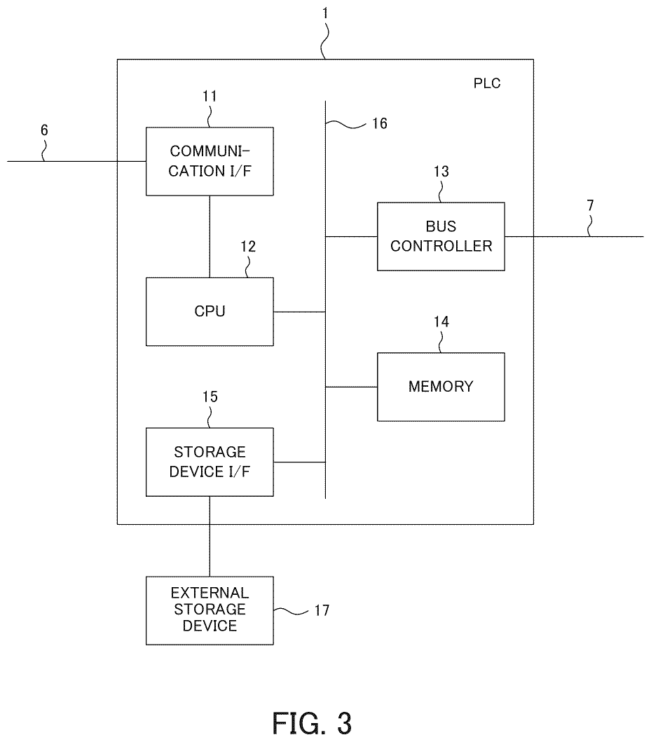

FIG. 3 illustrates an example of a hardware configuration of the PLC 1. As illustrated in FIG. 3, the PLC 1 includes a communication I/F 11, a central processing unit (CPU) 12, a bus controller 13, a memory 14, and a storage device I/F 15. All of these components are hardware and connected to an internal bus 16, and can transmit data to each other. “I/F” is an abbreviation of an interface. The CPU may also be referred to as a processor.

The communication I/F 11 is connected to the communication cable 6 and

communicates with the PC 2. The CPU 12 executes various programs such as the user program, a system program for managing the operation of the PLC 1, and a logging execution program. The bus controller 13 is connected to the communication bus 7 and communicates with the input/output module 3 and the communication module 4.

The memory 14 is, for example, a semiconductor memory, and includes a random access memory (RAM) area and a read only memory (ROM) area. The RAM area is used as a storage area for temporarily storing various types of data when the CPU 12 executes various programs. The ROM area is an area in which various programs and/or data are stored, and is implemented by, for example, a nonvolatile memory. The storage device I/F 15 manages write processing and read processing of various types of data with respect to an external storage device 17 such as a memory card.

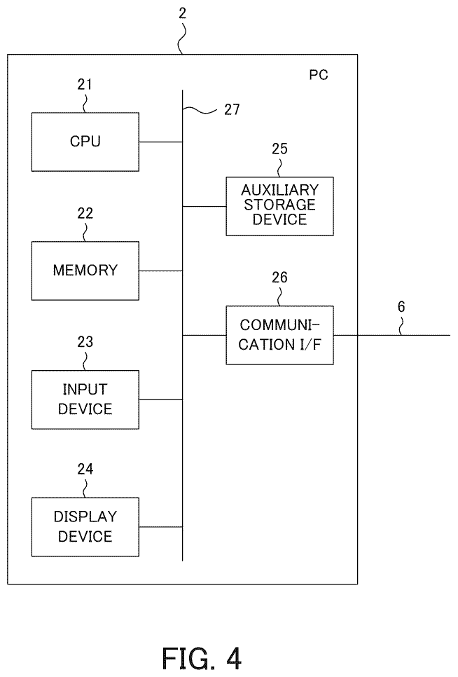

FIG. 4 illustrates an example of a hardware configuration of the PC 2. As illustrated in FIG. 4, the PC 2 includes a CPU 21, a memory 22, an input device 23, a display device 24, an auxiliary storage device 25, and a communication I/F 26. All of these components are hardware and connected to an internal bus 27, and can transmit data to each other.

The CPU 21 executes programs using the memory 22, for example, thereby providing a function of editing the user program, a function of creating a logging configuration representing the condition for executing the logging process, and the like. The input device 23 is, for example, a keyboard and/or a pointing device, and is used for input of an instruction or information from the user. The display device 24 displays an inquiry to the user, an instruction to the user, and a processing result, for example.

The auxiliary storage device 25 is implemented by, for example, a magnetic disk device, an optical disk device, a magneto-optical disk device, a hard disk drive, or a flash memory. Note that the PC 2 can store programs and data in the auxiliary storage device 25 and load and use the programs and data on the memory 22. The communication I/F 26 is connected to the communication cable 6 and communicates with the PLC 1.

### <Setting of Logging Process>

Information related to the logging process in the PLC 1 is set by the support device. The support device is implemented by the PC 2 illustrated in FIG. 1 or 4 executing a predetermined setting tool program. That is, the function of the support device is provided by the PC 2.

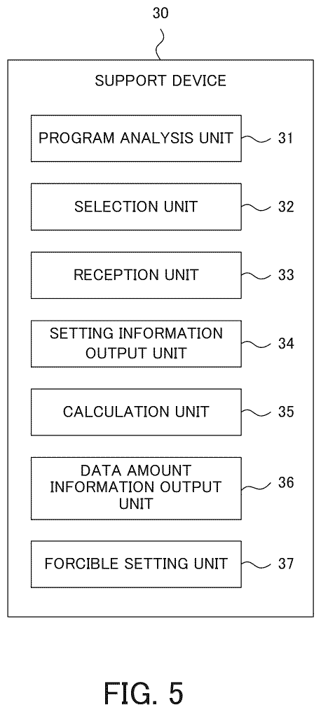

FIG. 5 illustrates an example of a functional configuration of a support device 30. The support device 30 sets the condition for executing the logging process in the PLC 1. That is, the support device 30 creates the logging configuration to be referred to by the PLC 1 and gives the logging configuration to the PLC 1. As illustrated in FIG. 5, the support device 30 includes a program analysis unit 31, a selection unit 32, a reception unit 33, a setting information output unit 34, a calculation unit 35, and a data amount information output unit 36. Note that the support device 30 may further have other functions not illustrated in FIG. 5. In addition, it is assumed that the control cycle when the PLC 1 is caused to execute the control processing illustrated in FIG. 2 is set in advance in the support device 30 by the user.

The program analysis unit 31 analyzes the user program to be executed by the PLC 1 and extracts the variables used in the user program. The selection unit 32 selects a variable (that is, collection target variable) to be collected in the logging process by the PLC 1 from among the variables extracted by the program analysis unit 31. When the forcible setting described below can be performed for the selected variable, the selection unit 32 may select, as targets to be collected in the logging process in the PLC 1, forcible setting reflected data, forcible setting data, and forcible setting validity information. The forcible setting data and the forcible setting validity information are examples of control information related to the forcible setting. The forcible setting reflected data, the forcible setting data, and the forcible setting validity information are described below.

The reception unit 33 receives designation of a predetermined collection period longer than the control cycle. A length of the collection period is, for example, N (N is an integer of 2 or more) times a length of the control cycle. The setting information output unit 34 outputs information indicating a plurality of collection target variables and information indicating the collection period as the logging configuration. In the following description, the variables (that is, the collection target variables) to be collected in the logging process may be simply referred to as “target variables”.

The PLC 1 executes the logging process based on the logging configuration output from the support device 30. At this time, the PLC 1 may distribute the plurality of target variables to a plurality of control cycles, and collect values of some variable among the plurality of collection target variables in each of the plurality of control cycles. Alternatively, the PLC 1 may collect the values of the respective target variables in each of the control cycles included in the collection period.

The calculation unit 35 determines the number of control cycles for collecting the values of the plurality of target variables based on the collection period and the control cycle. Then, the calculation unit 35 obtains an amount of data of values of the variables collected in each of the plurality of control cycles based on a total amount of data of the values of the plurality of target variables and the determined number of control cycles. The data amount information output unit 36 outputs data amount information indicating the amount of data calculated by the calculation unit 35.

With the support device 30 having the above-described function, it is possible to cause the PLC 1 to execute the logging process of collecting the values of the variables of a desired amount of data without affecting control of the external apparatus by the PLC 1. That is, the PLC 1 can appropriately collect the values of the variables used in the control of the apparatus. In addition, the support device 30 can cause the PLC 1 to collect the control information related to the forcible setting together with the variable values.

The support device 30 further includes a forcible setting unit 37. The forcible setting unit 37 gives the control information related to the forcible setting to the PLC 1 for each variable in the user program executed in the PLC 1. For example, the forcible setting unit 37 instructs implementation of the forcible setting for each variable used in the PLC 1. In addition, the forcible setting unit 37 can transmit a memory address and a forcible setting value of each variable used in the PLC 1 to the PLC 1 via the communication I/F 26 based on a user instruction received using a user interface (UI).

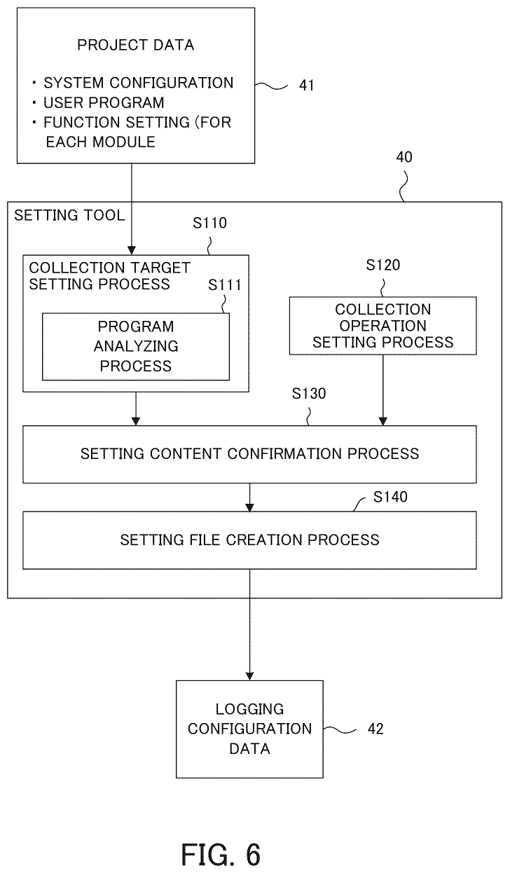

FIG. 6 illustrates an example of a method for creating the logging configuration. This method corresponds to a support method used by the support device 30 illustrated in FIG. 5.

The support device 30 includes a setting tool 40. In the PC 2, a function of the setting tool 40 is provided by causing the CPU 21 to execute the predetermined setting tool program.

Project data 41 is input to the setting tool 40. The project data 41 includes information related to a system configuration of the PLC system 10, the user program executed by the PLC 1, and information related to function settings of the input/output module 3 and the communication module 4 included in the PLC system 10. Here, it is assumed that the project data 41 is created by the user executing a predetermined project data editing program in the PC 2, for example, and is stored in the auxiliary storage device 25.

The setting tool 40 executes collection target setting process S110 on the project data 41. At this time, the setting tool 40 determines a variable to be a logging target from the variables used in the user program. Note that the setting tool 40 provides the functions of the program analysis unit 31 and the selection unit 32 in the support device 30 illustrated in FIG. 5.

The collection target setting process S110 includes a program analyzing process S111. The program analyzing process S111 analyzes the user program included in the project data 41 and extracts the variables used in the user program. In the collection target setting process S110, the target variables (that is, the variables to be collected in the logging process executed by the PLC 1) are selected from the variables extracted in the program analyzing process S111. Further, the collection target setting process S110 creates an instruction or information indicating that the control information related to the forcible setting is collected in the logging process for the target variable for which the forcible setting can be performed.

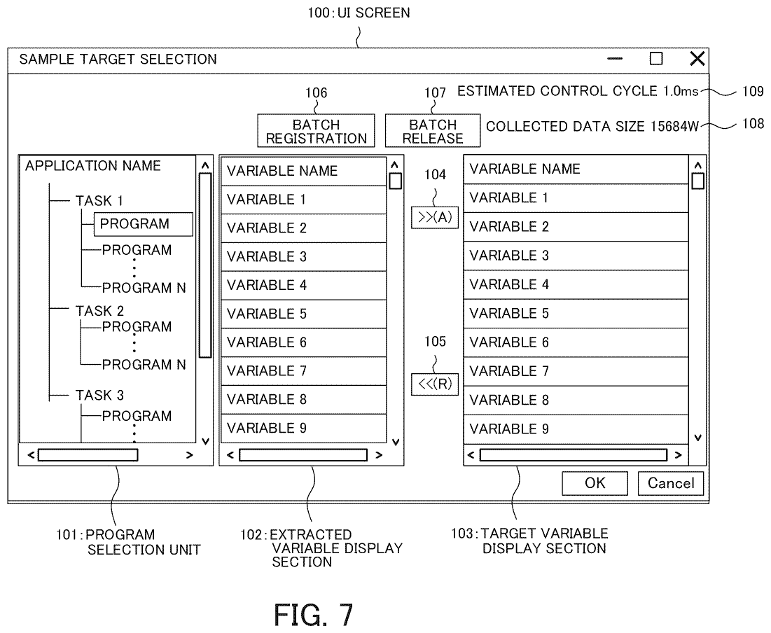

Here, a UI screen 100 used in the collection target setting process S110 will be described with reference to FIG. 7. “UI” is an abbreviation of a user interface.

In an example illustrated in FIG. 7, the UI screen 100 includes a program selection section 101, an extracted variable display section 102, and a target variable display section 103. When the function of the support device 30 is provided by the PC 2 illustrated in FIG. 4, the UI screen 100 is displayed by the display device 24.

The program selection section 101 displays information indicating the user program included in the project data 41. In the present embodiment, a task is configured as an aggregate of a plurality of programs, and the user program is configured as an aggregate of a plurality of tasks. In the screen example illustrated in FIG. 7, “APPLICATION NAME” is a name of the user program, “TASK 1”, “TASK 2”, and “TASK 3” are names of the tasks, and “PROGRAM” to “PROGRAM N” are names of programs belonging to each of the tasks. In the screen example, a relationship among the user program, the respective tasks, and the respective programs is indicated in a tree format.

When any one of the names of the programs displayed on the program selection section 101 is selected by the user, the program analyzing process S111 is executed on the selected program, and variables used in the program are extracted. In a case where a name of a task is selected instead of the name of the program, variables are extracted from each of the programs belonging to the selected task. At this time, names of the extracted variables are displayed on the extracted variable display section 102.

When the user selects one or more names from among the names of the variables displayed on the extracted variable display section 102 and further presses a registration button 104, variables corresponding to the selected names are selected as the target variables. At this time, the names of the selected target variables are displayed on the target variable display section 103. When the user performs an operation of selecting one or more names from among the names of the target variables displayed on the target variable display section 103 and pressing a release button 105, the selected variables are excluded from a target variable selection result.

When the user performs an operation of pressing a batch registration button 106, all the variables displayed on the extracted variable display section 102 are selected as the target variables, and the names thereof are displayed on the target variable display section 103. On the other hand, when the user performs an operation of pressing a batch release button 107, all the variables displayed on the target variable display section 103 are excluded from the target variable selection result.

In the collection target setting process S110, a total amount of data collected when the logging process is executed for all the target variables selected as described above is calculated based on the project data 41. The calculated total amount of data is displayed on a collected data size display section 108 in the UI screen 100.

When the selected collection target is a variable for which the forcible setting can be performed, the control information related to the forcible setting is also collected in the logging process. Therefore, in this case, the total amount of data may include the amount of data of the control information related to the forcible setting. In general, since the input/output module 3 that can be controlled by the PLC 1 is determined in advance, the total amount of data does not have to include the amount of data of the control information related to the forcible setting, so that the user does not have to be conscious of the total amount of data.

An execution time of each of the input process, the program execution process, the output process, and the system process within one cycle of the control processing executed by the PLC 1 can be calculated from the project data 41. In addition, in the collection target setting process S110, an execution time of the logging process when the logging process is executed for the selected target variables is estimated. Then, a total value of the execution times is calculated. Such a total execution time is a time estimated to be required for executing one cycle of the control processing executed by the PLC 1. The total value is displayed on an estimated control cycle display section 109 in the UI screen 100.

The description returns to FIG. 6. In collection operation setting process S120, the setting tool 40 creates information for operation setting of the logging process. Based on the information, for example, a collection timing of the values of the target variables as collection target data, a period during which the data is collected, a storage timing at which the PLC 1 stores the collected data in the external storage device 17, and the like are set in the PLC 1.

In setting content confirmation process S130, it is determined whether the execution time of one cycle of the control processing when the PLC 1 executes the logging process for all the target variables selected in the collection target setting process S110 falls within a preset control cycle.

Setting file creation process S140 corresponds to the function of the reception unit 33 in the support device 30 illustrated in FIG. 5. In the setting file creation process S140, information specifying the target variables selected in the collection target setting process S110 and operation setting information of the logging process set in the collection operation setting process S120 are output as logging configuration data 42. The logging configuration data 42 is transmitted to the PLC 1. The PLC 1 executes the logging process based on a content of the logging configuration data 42.

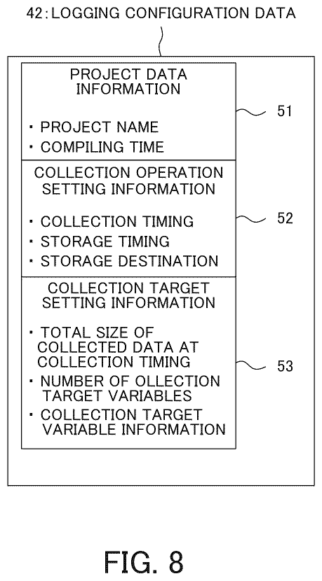

FIG. 8 illustrates an example of the logging configuration data 42. As illustrated in FIG. 8, the logging configuration data 42 includes project data information 51, collection operation setting information 52, and collection target setting information 53.

The project data information 51 is information for specifying the user program to be executed by the PLC 1, and includes, for example, information such as a name attached to an object code obtained by compiling the user program and execution date and time of the compiling. Note that the project data information 51 may be a part of the project data 41.

The collection operation setting information 52 is created by the collection operation setting process S120. The collection operation setting information 52 includes, for example, information indicating a data collection timing, information indicating a period during which data is collected, information indicating a timing at which the PLC 1 stores the collected data in the external storage device 17, and information specifying the external storage device 17 that stores the collected data.

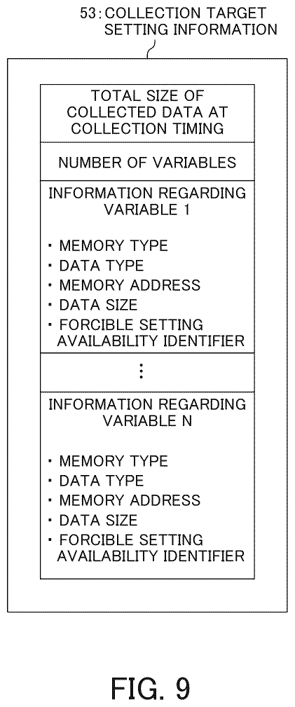

The collection target setting information 53 includes information related to the target variables selected by the collection target setting process S110. As illustrated in FIG. 9, the collection target setting information 53 includes information indicating a total size of the collected data at the data collection timing. The collection target setting information 53 includes information indicating the number of target variables that are data collection targets. Furthermore, the collection target setting information 53 includes information indicating a memory type, a data type, the memory address, and a data size for each of the target variables. Based on these pieces of information, a position and a size of a storage area (that is, a storage area in which a value to be collected in the logging process is held) used to hold the value of the target variable on the memory 14 are specified when the PLC 1 executes the user program.

The collection target setting information 53 further includes a forcible setting availability identifier for each of the target variables. The forcible setting availability identifier indicates whether or not the forcible setting can be performed for the variable. For example, the user of the PLC system 10 determines whether or not the forcible setting can be performed.

When the target variable is a variable for which the forcible setting can be performed, the collection target setting process S110 designates the control information related to the forcible setting as the collection target in the logging process in addition to the variable value. That is, the instruction or the information indicating that the control information related to the forcible setting is collected in the logging process in the PLC 1 is created for the target variable for which the forcible setting can be performed. The collection target setting process S110 recognizes the correspondence between the memory address of the variable used on the project data 41 and the memory area on the memory 14 of the PLC 1.

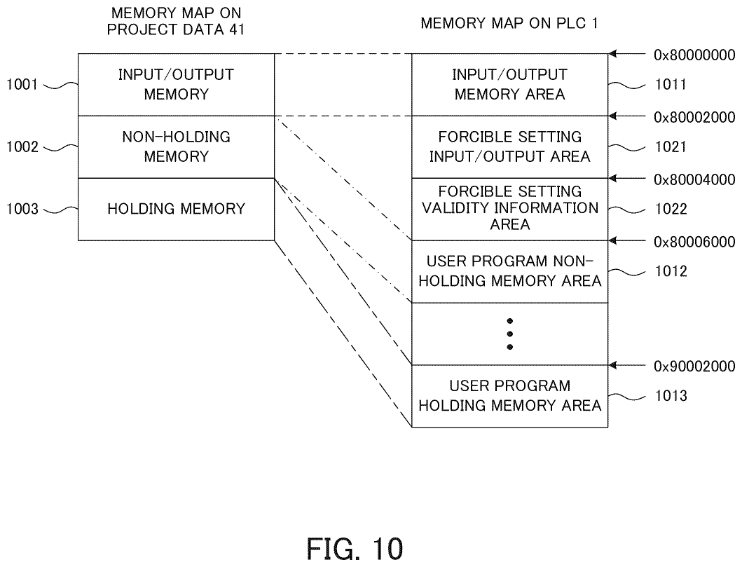

FIG. 10 illustrates an example of the correspondence between the memory address of the variable used on the project data 41 and the memory area on the memory 14 of the PLC 1. An input/output memory 1001 represents an area to which an address corresponding to a variable related to the input/output module 3 used in the user program is assigned. A non-holding memory 1002 represents an area to which an address corresponding to a variable for operating a non-holding memory used in the user program is assigned. A holding memory 1003 represents an area to which an address corresponding to a variable for operating a holding memory used in the user program is assigned.

The input/output memory area 1011 represents an area corresponding to the input/output memory 1001 in the memory 14 of the PLC 1. The PLC 1 may control data via the input/output module 3 and the input/output memory area 1011. A user program non-holding memory area 1012 represents an area corresponding to the non-holding memory 1002 actually used in the memory 14 of the PLC 1. A user program holding memory area 1013 represents an area corresponding to the holding memory 1003 actually used in the memory 14 of the PLC 1.

A forcible setting input/output area 1021 is an area for writing the forcible setting data to a corresponding address position in a case where the forcible setting can be performed for the variable related to the input/output module 3. A forcible setting validity information area 1022 is an area for writing information indicating whether the forcible setting is valid or invalid (forcible setting validity information) to a corresponding address position in a case where the forcible setting can be performed for the variable related to the input/output module 3.

In this manner, the support device 30 can set the condition related to the execution of the logging process in the PLC 1 by using the setting tool 40. When the variable of the input/output memory 1001 is a variable for which the forcible setting can be performed, the collection target setting process S110 designates the input/output memory area 1011, the forcible setting input/output area 1021, and the forcible setting validity information area 1022 as addresses for which data is to be collected in the logging process. These pieces of information are set as “memory addresses” in the collection target setting information 53 illustrated in FIG. 9. That is, for a variable for which the forcible setting can be performed, the input/output memory area 1011, the forcible setting input/output area 1021, and the forcible setting validity information area 1022 are set as the collection targets in the logging process in the collection target setting information 53.

The logging configuration data 42 including the collection target setting information 53 is transmitted from the PC 2 to the PLC 1. Then, the PLC 1 executes the logging process according to the logging configuration data 42. Therefore, the PLC 1 can execute the logging process without being conscious of the memory type of each variable used in the project data 41.

### <Execution of Logging Process>

The logging process executed by the PLC 1 in the PLC system 10 illustrated in FIG. 1 will be described. The PLC 1 executes the logging process according to the logging configuration data 42 created by the PC 2 operating as the support device 30. Although not particularly illustrated, the logging configuration data 42 is stored in a predetermined area in the memory 14 included in the PLC 1.

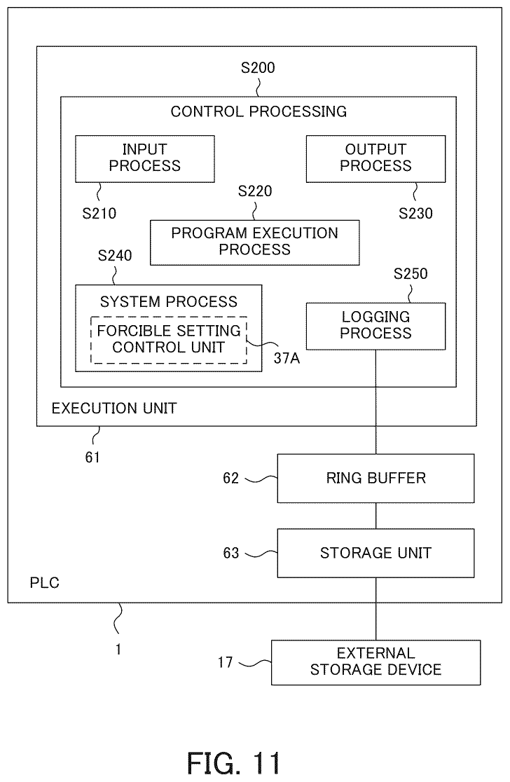

FIG. 11 illustrates an example of a functional configuration of the PLC 1. In the example illustrated in FIG. 11, the PLC 1 includes an execution unit 61, a ring buffer 62, and a storage unit 63. It is assumed that the control cycle for performing the control processing described above is set in advance in the PLC 1 by the user.

The PLC 1 repeatedly executes control processing S200 including an input process S210, a program execution process S220, an output process S230, a system process S240, and a logging process S250. In the functional configuration example illustrated in FIG. 11, the execution unit 61 repeatedly executes the control processing S200. In the hardware configuration example illustrated in FIG. 3, the control processing is executed by the CPU 12. The system process S240 provides a forcible setting control unit 37A. The forcible setting control unit 37A sets the forcible setting data and the forcible setting validity information in the PLC 1 based on an instruction or information related to the forcible setting given from the forcible setting unit 37 implemented in the PC 2.

The ring buffer 62 is a storage area that stores sampled data including a data collection time in the logging process S250 and a value of a target variable collected at the data collection time each time the value of the target variable is collected. In the hardware configuration example illustrated in FIG. 3, the ring buffer 62 is implemented by a part of a storage area of the memory 14.

The logging process S250 collects the value of the designated target variable according to the logging configuration data 42. Here, for the variable for which the forcible setting described below can be performed, the logging process S250 also collects the control information related to the forcible setting. In this case, the sampled data stored in the ring buffer 62 includes the variable value and the control information related to the forcible setting. The control information includes information indicating whether or not the forcible setting has been performed.

The storage unit 63 sequentially reads the same data stored without being discarded from the ring buffer 62 and stores the sampled data in the external storage device 17. In the hardware configuration example illustrated in FIG. 3, the storage device I/F 15 may provide the function of the storage unit 63 according to the control of the CPU 12. At this time, the execution unit 61 provided by the CPU 12 may control the storage device I/F 15 as a part of the logging process S250.

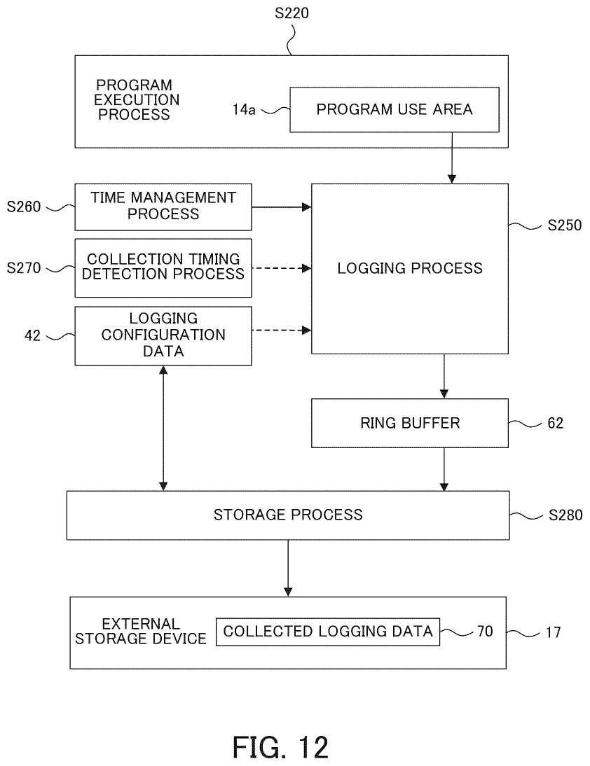

FIG. 12 illustrates an example of the logging process executed by the PLC 1. The PLC 1 has the same functional configuration as described with reference to FIG. 11.

The program execution process S220 executes the user program using input data obtained by the input process S210 and sent from the input/output module 3, the communication module 4, or the like. A result of the execution is output by the output process S230 to control an external apparatus. In the hardware configuration example illustrated in FIG. 3, the CPU 12 that executes the program execution process S220 uses the storage area of the memory 14 to execute the user program. The storage area used at this time is referred to as a “program use area 14a”.

The logging process S250 collects a value of each of the target variables from the variables used in the user program executed by the program execution process S220. It is assumed that the logging configuration data 42 including the collection operation setting information 52 and the collection target setting information 53 illustrated in FIGS. 8 and 9 is created in the support device 30 (PC 2) and provided to the PLC 1 in advance.

The CPU 12 of the PLC 1 executes time management process S260 and collection timing detection process S270 in parallel with the control processing S200. The time management process S260 measures the current time. The collection timing detection process S270 detects arrival of the data collection timing indicated by the collection operation setting information 52 included in the logging configuration data 42.

When the collection timing is detected in the collection timing detection process S270, the logging process S250 collects the value of each of the target variables. In addition, the logging process S250 acquires the collection time of each value from a time measurement result of the time management process S260, and stores the sampled data in which the value and the collection time are associated with each other in the ring buffer 62.

The CPU 12 of the PLC 1 executes a storing process S280. The storing process S280 includes process of detecting arrival of the storage timing indicated by the collection operation setting information 52 included in the logging configuration data 42. In addition, the storing process S280 controls the storage device I/F 15 according to the detection of the arrival of the storage timing to read the sampled data stored in the ring buffer 62. Then, the storing process S280 stores the read sampled data in the external storage device 17. A storage destination is indicated by the collection operation setting information 52.

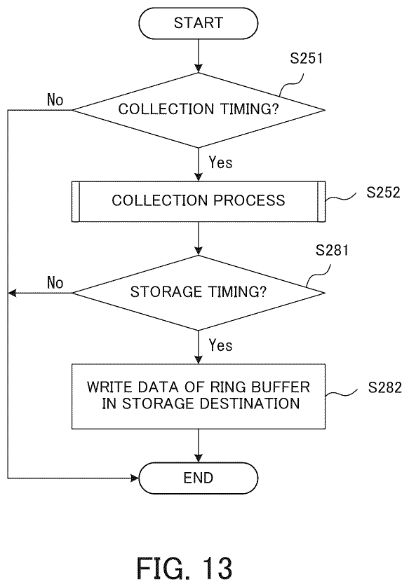

FIG. 13 is a flowchart illustrating an example of the logging process S250 and the storing process S280. Processing in this flowchart is executed when a start timing of the logging process arrives in each cycle of the control processing S200.

In S251, the execution unit 61 determines whether or not the collection timing has arrived in the collection timing detection process S270. When the arrival of the collection timing has been detected (S251: Yes), a collection process is executed in S252. The collection process includes a process of collecting the value of each of the target variables and a process of storing the collected value in the ring buffer 62 as sampled data 73 described below. Details of the collection process are described below. On the other hand, when the arrival of the collection timing has not been detected (S251: No), the process illustrated in FIG. 13 ends.

In S281, the storage unit 63 determines whether or not the storage timing has arrived. The storage timing is indicated by the collection operation setting information 52 included in the logging configuration data 42. When the storage timing has arrived (S281: Yes), the process in the storage unit 63 proceeds to S282. On the other hand, when the storage timing has not arrived (S281: No), the process illustrated in FIG. 13 ends without performing the process of S282. In S282, the storage unit 63 reads the sampled data stored in the ring buffer 62 in the logging process. Then, the storage unit 63 stores the read sampled data as collected logging data 70 in the storage destination (here, the external storage device 17) indicated by the collection operation setting information 52.

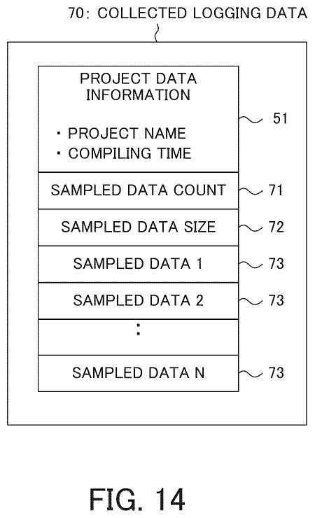

FIG. 14 illustrates an example of a data structure of the collected logging data 70. The collected logging data 70 includes project data information 51, a sampled data count 71, a sampled data size 72, and one or more pieces of sampled data 73.

The project data information 51 is information for specifying the user program executed by the PLC 1, and includes, for example, information such as the name attached to the object code obtained by compiling the user program and the execution date and time of the compiling. That is, the project data information 51 included in the collected logging data 70 is similar to the project data information 51 included in the logging configuration data 42. In the collection process S252, the CPU 12 may acquire the project data information 51 from the logging configuration data 42 and write the acquired project data information 51 in the collected logging data 70.

The sampled data count 71 represents the number of pieces of sampled data 73 included in the collected logging data 70. The sampled data size 72 represents a total amount of the pieces of sampled data 73 included in the collected logging data 70. Each piece of the sampled data 73 is data representing the value of the target variable collected in the logging process, and is written in the collected logging data 70 in a collected order.

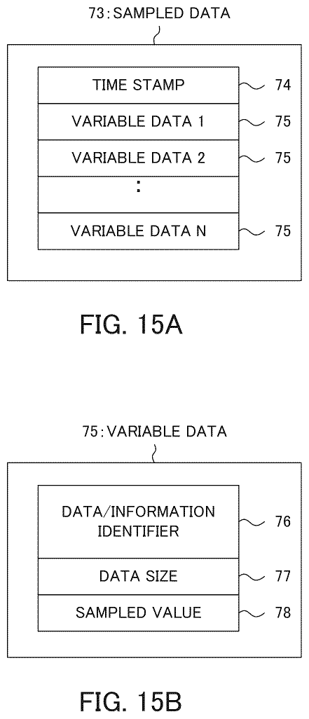

FIG. 15A illustrates an example of a data structure of the sampled data 73. In this example, the sampled data 73 includes a timestamp 74. The timestamp 74 indicates a time at which the value of the target variable is collected. Each piece of variable data 75 includes information related to the target variable collected at the time indicated by the timestamp 74. Specifically, each piece of variable data 75 includes a data/information identifier 76, a data size 77, and a sampled value 78, as illustrated in FIG. 15B.

The data/information identifier 76 represents a type of data or information stored as the sampled value 78. As an example, the data/information identifier 76 represents whether the value stored as the sampled value 78 is the forcible setting data, the forcible setting validity information, the forcible setting reflected data, or non-forcible-setting-target data. The data size 77 represents an amount of data of the sampled value 78. The sampled value 78 represents a value of data or information acquired in the logging process.

Here, the PLC 1 recognizes whether or not the forcible setting can be performed for each variable by referring to the collection target setting information 53 illustrated in FIG. 9. For the variable for which the forcible setting cannot be performed, the PLC 1 acquires and stores the non-forcible-setting-target data as the sampled value 78. At this time, the non-forcible-setting-target data is collected from, for example, the input/output memory area 1011 illustrated in FIG. 10. For a variable for which the forcible setting can be performed, the PLC 1 acquires and stores each of the forcible setting data, the forcible setting validity information, and the forcible setting reflected data as the sampled value 78. At this time, the forcible setting data, the forcible setting validity information, and the forcible setting reflected data are collected from, for example, the input/output memory area 1011, the forcible setting input/output area 1021, and the forcible setting validity information area 1022 illustrated in FIG. 10, respectively. In a case where a position for or an order of storing the forcible setting data, the forcible setting validity information, and the forcible setting reflected data is predetermined, the variable data 75 does not have to include the data/information identifier 76. In addition, the data/information identifier 76 may include an address at which the forcible setting data, the forcible setting validity information, and the forcible setting reflected data are to be stored.

When the logging process illustrated in FIGS. 12 and 13 ends, the CPU 12 stores the logging configuration data 42 in the external storage device 17. The logging configuration data 42 is also used when the sampled data 73 is displayed.

### <Forcible Setting>

In the PLC system 10, as described above, the PLC 1 collects the values of the target variables used in the user program according to the logging configuration data 42. Then, the PLC 1 generates control data for controlling the external apparatus based on the collected values of the variables. For example, the PLC 1 acquires displacement data output from a predetermined sensor, and generates the control data by substituting the displacement data into the variable used in the user program. Then, the external apparatus operates according to the control data. That is, the external apparatus operates according to the displacement data. Therefore, in a case where the displacement data indicates an abnormal value, the external apparatus cannot normally operate. Therefore, when an abnormal value is detected from the collected values, the PLC system 10 performs the forcible setting for forcibly replacing the value with a predetermined value.

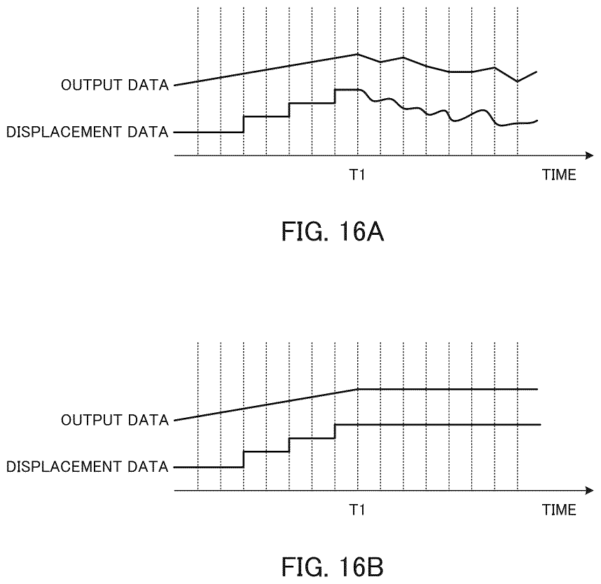

FIGS. 16A and 16B illustrate examples of the forcible setting performed in the PLC system 10. For example, in a case illustrated in FIG. 16A, the sensor fails at time T1, and an abnormal value of the displacement data is detected. In this case, when the displacement data is given to the user program, normal control data is not generated, and the external apparatus cannot normally operate.

Therefore, when the abnormal value of the displacement data is detected at time T1, the PLC system 10 gives the predetermined value to the user program instead of the displacement data acquired from the sensor as illustrated in FIG. 16B. As a result, an abnormal operation of the external apparatus is avoided.

In this example, the user of the PLC system 10 can determine whether or not to perform the forcible setting. For example, the user monitors the value of the variable used in the PLC 1 by using the PC 2. When the abnormal value is detected, the user requests the PLC 1 to perform the forcible setting for the corresponding variable by using the PC 2. At this time, information indicating a variable for which the forcible setting can be performed is reported from the PC 2 to the PLC 1 as, for example, the forcible setting availability identifier. Then, the PLC 1 stores the information indicating a variable for which the forcible setting can be performed in a predetermined memory area.

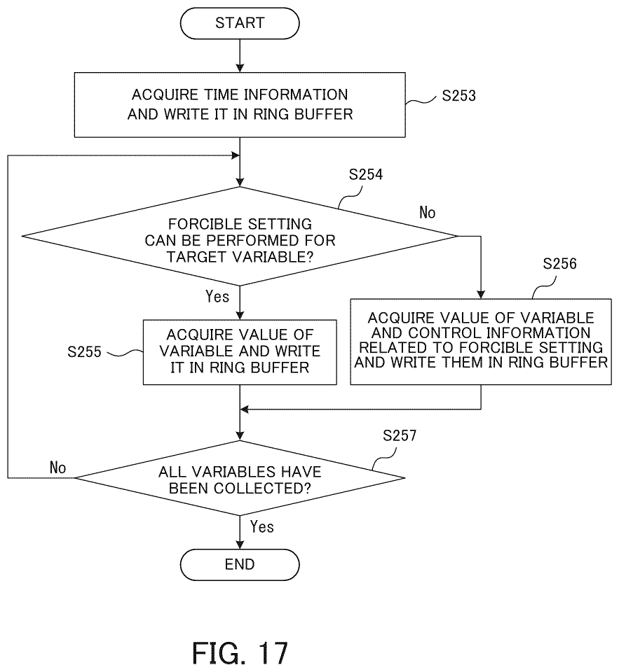

FIG. 17 is a flowchart illustrating an example of the collection process. The collection process corresponds to S252 illustrated in FIG. 13. In the PLC system 10, it is assumed that whether or not the forcible setting can be performed is designated in advance for each variable in the user program executed by the PLC 1. The PC 2 notifies the PLC 1 of information indicating whether or not the forcible setting can be performed (forcible setting availability identifier) for each variable.

In S253, the execution unit 61 acquires the current time measured by the time management process S260 as the timestamp. Then, the execution unit 61 writes the acquired timestamp in the ring buffer 62 as data of a head position of the sampled data 73. Thereafter, steps of process of S254 to S256 are executed for each target variable.

In S254, the execution unit 61 determines whether or not the target variable is a variable for which the forcible setting can be performed. Here, whether or not the forcible setting can be performed is determined by the user as described above, and is reported from the PC 2 to the PLC 1. Then, the execution unit 61 executes the corresponding logging process according to whether or not the target variable is a variable for which the forcible setting can be performed.

Here, the collection target in the logging process is reported from the PC 2 to the PLC 1 by using the logging configuration data 42. Specifically, for a variable for which the forcible setting is not performed, a memory address for storing a value of the variable is designated in the collection target setting information 53 illustrated in FIG. 9. In the example illustrated in FIG. 10, an address of the “input/output memory area 1011” is designated. For a variable for which the forcible setting can be performed, a memory address for storing a value of the variable and a memory address for storing the control information related to the forcible setting are designated in the collection target setting information 53 illustrated in FIG. 9. In the example illustrated in FIG. 10, addresses of the “input/output memory area 1011”, the “forcible setting input/output area 1021”, and the “forcible setting validity information area 1022” are designated.

When the target variable is not a variable for which the forcible setting can be performed, the execution unit 61 acquires the current value of the target variable in S255. At this time, the execution unit 61 acquires the variable value written in the “input/output memory area 1011”. Then, the execution unit 61 writes the acquired variable value in the ring buffer 62 in association with time information indicating a time at which the value of the target variable is acquired. In FIG. 15B, the acquired variable value is stored as the sampled value. In addition, a value indicating the non-forcible-setting-target data is set as the data/information identifier 76.

When the target variable is a variable for which the forcible setting can be performed, the execution unit 61 acquires the current value of the target variable and the control information related to the forcible setting in S256. That is, the execution unit 61 acquires the values written in the “input/output memory area 1011”, the “forcible setting input/output area 1021”, and the “forcible setting validity information area 1022”, respectively. Then, the execution unit 61 writes the acquired variable value and control information related to the forcible setting in the ring buffer 62 in association with the time information indicating the time at which the value of the target variable is acquired. The control information related to the forcible setting is the forcible setting data and the forcible setting validity information described below. In this case, in FIG. 15B, the acquired variable value, the forcible setting data, and the forcible setting validity information are stored as the sampled values. At this time, a value representing the forcible setting reflected data, a value representing the forcible setting data, and a value representing the forcible setting validity information are set as the data/information identifiers 76 corresponding to the respective sampled values.

A position where the value to be collected (the variable value, the forcible setting data, and the forcible setting validity information) is held is specified based on the information indicating the memory type, the data type, the memory address, and the data size included in the collection target setting information 53 of the logging configuration data 42. Therefore, by reading the data held at this position, the value of the collection target is acquired and written to the ring buffer 62.

In S257, the execution unit 61 determines whether or not the values of all the target variables registered in the collection target setting information 53 of the logging configuration data 42 have been collected. When the values of all the target variables have been collected (S257: Yes), the collection process ends. On the other hand, when there remains a target variable whose value has not been collected (S257: No), the process in the execution unit 61 returns to S254. That is, the execution unit 61 acquires a value related to the next target variable. Then, when the values related to all the target variables are acquired and the storage in the ring buffer 62 is completed, the storing process S280 is executed.

As described above, for a variable for which the forcible setting can be performed, the execution unit 61 of the PLC 1 also acquires the control information related to the forcible setting when acquiring the values of the target variables used in the user program. Then, the acquired variable value and control information related to the forcible setting are stored in the ring buffer 62 as the variable data. Therefore, it is possible to recognize whether or not the forcible setting has been performed for each target variable by referring to the variable data stored in the ring buffer 62. The variable value and the control information are recorded in association with the time at which the variable value is collected. Therefore, a time or period when the forcible setting is performed can be specified for each target variable by referring to the variable data stored in the ring buffer 62.

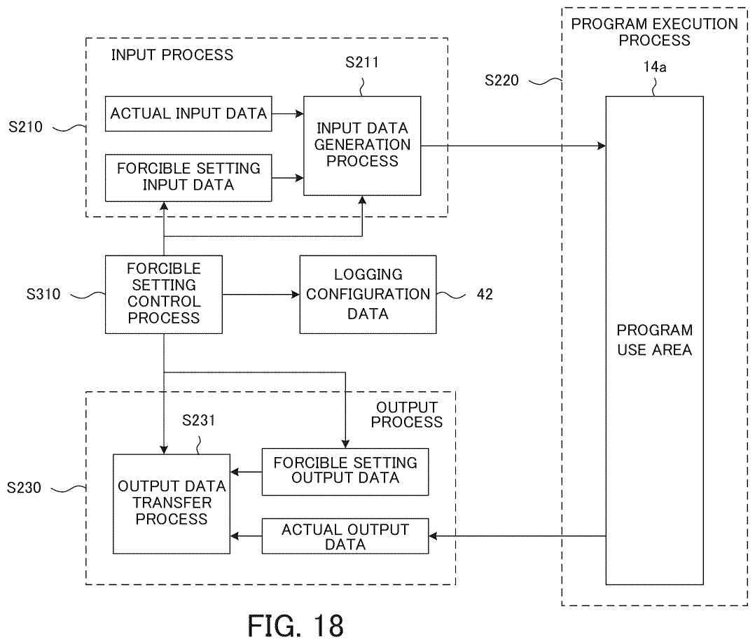

FIG. 18 illustrates an example of a functional configuration related to the forcible setting of the variable. It is assumed that the cycle of the control processing illustrated in FIG. 2 is set for the PLC 1 by the user.

As described above, the PLC 1 repeatedly executes the control processing S200 including the input process S210, the program execution process S220, the output process S230, the system process S240, and the logging process S250 illustrated in FIG. 2 or 11. The control processing S200 is executed by the execution unit 61 illustrated in FIG. 11. In the hardware configuration example illustrated in FIG. 3, the control processing S200 is executed by the CPU 12.

Actual input data represents data given to the PLC 1 via the input/output module 3 illustrated in FIG. 1. For example, the actual input data is sensor data detected by a sensor in the external apparatus to be controlled. Forcible setting input data is a fixed value generated by forcible setting control process S310 for each variable used in the user program.

An Input data generation process S211 generates input data to be given to a corresponding variable in the user program. At this time, the input data generation process S211 may generate the input data to be given to the user program by selecting any one of the actual input data or the forcible setting input data. The input data generated by the input data generation process S211 is written in the program use area 14a. The input data written in the program use area 14a is used in the program execution process S220.

Actual output data is generated by execution of the user program in the program execution process S220. The actual output data is obtained by extracting data for controlling the external apparatus from an arithmetic operation result of the program execution process S220. Forcible setting output data is a fixed value generated by the forcible setting control process S310 for each variable representing the control data for controlling the external apparatus.

An Output data transfer process S231 transfers the control data to the external apparatus to be controlled by the PLC 1. At this time, the output data transfer process S231 may generate the control data obtained by selecting any one of the actual output data or the forcible setting output data and transfer the control data to the external apparatus. The external apparatus operates according to the control data transferred by the output data transfer process S231.

The forcible setting control process S310 is executed by the PC 2 operating as the support device 30, for example. In this case, the forcible setting control process S310 corresponds to a process of reflecting the forcible setting from the PC 2 to the PLC 1 via the communication cable 6. However, a part of the forcible setting control process S310 is executed in the PLC 1. That is, the forcible setting control process S310 may be implemented by cooperative operation of the PC 2 and the PLC 1. In this case, the forcible setting control process S310 corresponds to the forcible setting unit 37 illustrated in FIG. 5 and the forcible setting control unit 37A illustrated in FIG. 11.

The forcible setting control process S310 controls a process related to the forcible setting according to whether or not the forcible setting is performed for each variable used by the user program. Further, the forcible setting control process S310 may generate the forcible setting input data corresponding to each variable and the forcible setting output data corresponding to each variable, and control the input data generation process S211 and the output data transfer process S231.

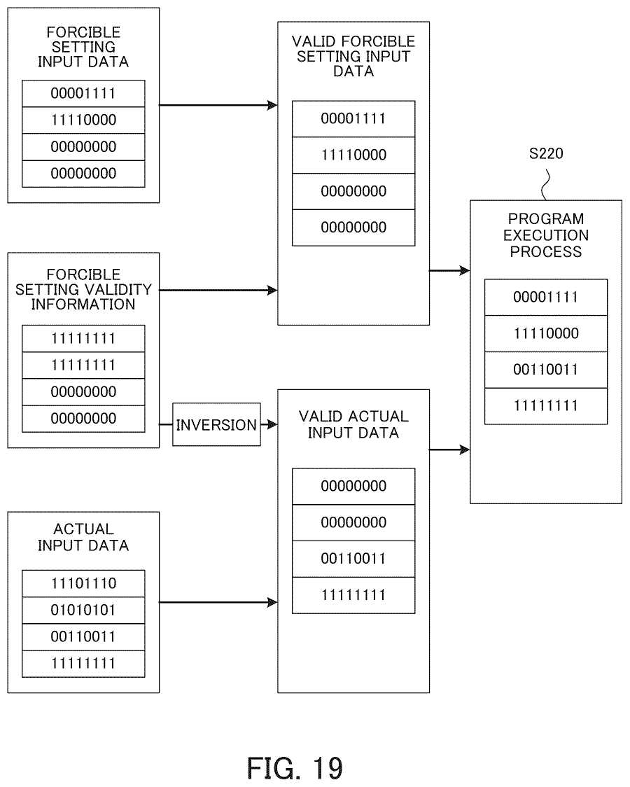

FIG. 19 illustrates an example of the input data generation process S211. In this example, the input data is given to each of four variables used in the program execution process S220 in the PLC 1. Each piece of input data is represented by 8 bits.

The forcible setting validity information for the input data is generated by the forcible setting control process S310, and indicates whether or not the forcible setting is valid for each piece of input data (or each variable). The forcible setting validity information may be 1-bit information or information indicating the address position. In this example, the forcible setting validity information is represented by the same number of bits as the input data. Specifically, the forcible setting validity information corresponding to the input data for which the forcible setting is to be performed is “11111111”, and the forcible setting validity information corresponding to the input data for which the forcible setting is not to be performed is “00000000”. In this example, the forcible setting is performed for the first input data and the second input data, and the forcible setting is not performed for the third input data and the fourth input data.

As described above, the forcible setting control process S310 determines whether or not to perform the forcible setting for each variable. Then, the forcible setting control process S310 generates the forcible setting validity information corresponding to each variable according to the determination.

The input data generation process S211 performs an AND operation of the forcible setting input data and the forcible setting validity information for each variable. As a result, valid forcible setting input data is obtained. In addition, the input data generation process S211 performs an AND operation of the actual input data and inverted data of the forcible setting validity information for each variable. As a result, valid actual input data is obtained. Furthermore, the input data generation process S211 performs an OR operation of the valid forcible setting input data and the valid actual input data for each variable. As a result, input data to be given to the user program is generated.

The input data generation process S211 may generate the input data to be given to the user program by another method. For example, the input data generation process S211 may select one of the actual input data and the forcible setting input data for each variable according to whether or not to perform the forcible setting.

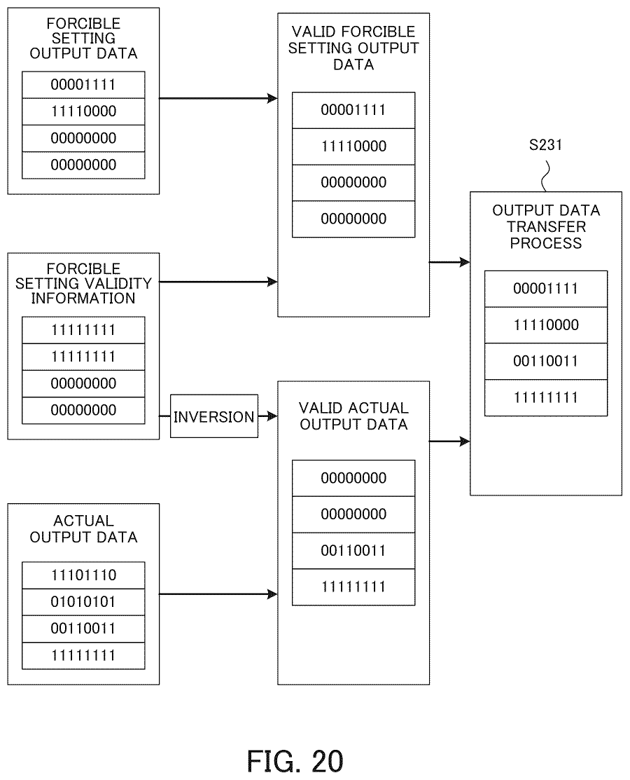

FIG. 20 illustrates an example of the output data transfer process S231. In this example, the control data is output from each of the four variables used in the program execution process S220 in the PLC 1. Each piece of output data is represented by 8 bits.

The forcible setting validity information for the output data is generated by the forcible setting control process S310, and indicates whether or not the forcible setting is valid for each output data (or each variable). The forcible setting validity information may be 1-bit information or information indicating the address position. In this example, the forcible setting validity information is represented by the same number of bits as the output data. Specifically, the forcible setting validity information corresponding to the output data for which the forcible setting is to be performed is “11111111”, and the forcible setting validity information corresponding to the output data for which the forcible setting is not to be performed is “00000000”. In this example, the forcible setting is performed for the first output data and the second output data, and the forcible setting is not performed for the third output data and the fourth output data.

As described above, the forcible setting control process S310 determines whether or not to perform the forcible setting for each variable. Then, the forcible setting control process S310 generates the forcible setting validity information corresponding to each variable according to the determination.

The output data transfer process S231 performs an AND operation of the forcible setting output data and the forcible setting validity information for each variable. As a result, valid forcible setting output data is obtained. In addition, the output data transfer process S231 performs an AND operation of the actual output data and inverted data of the forcible setting validity information for each variable. As a result, valid actual output data is obtained. Further, the output data transfer process S231 performs an OR operation of the valid forcible setting output data and the valid actual output data for each variable. As a result, the control data to be given to the apparatus to be controlled is generated.

The output data transfer process S231 may generate the control data to be given to the apparatus by another method. For example, the output data transfer process S231 may select one of the actual output data and the forcible setting output data for each variable depending on whether or not to perform the forcible setting.

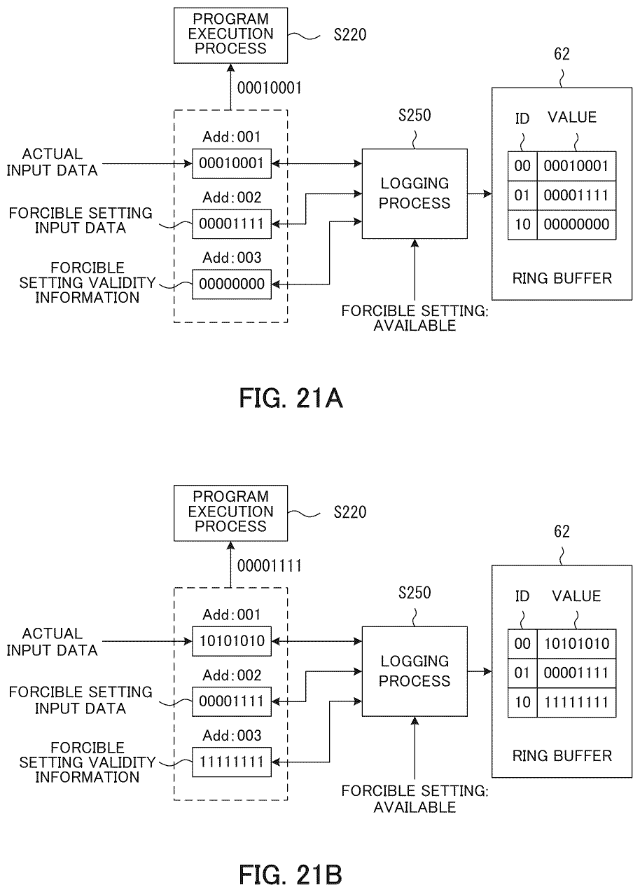

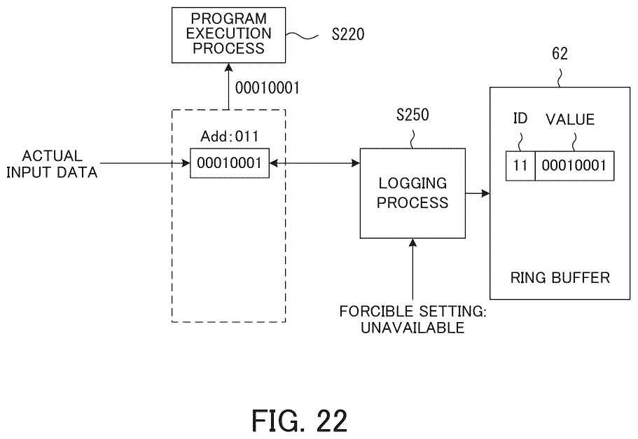

FIGS. 21A to 22 illustrate examples of the forcible setting and the logging process related to the input data. FIGS. 21A to 22 illustrate a process for one of the plurality of target variables.

The execution unit 61 of the PLC 1 includes a memory that stores data/information related to the variables used by the user program. A predetermined memory area is allocated to each target variable. In this example, addresses 001 to 003 are allocated to the target variable. The actual input data received via the input/output module 3 or the communication module 4 is written to the address 001. The actual input data may be replaced with the forcible setting data, and thus is an example of the forcible setting reflected data. The forcible setting input data for the target variable is stored in the address 002. The forcible setting validity information indicating whether or not the forcible setting is performed for the target variable is stored in the address 003.

The data/information identifier is as follows in this example.
00: Actual input data (forcible setting reflected data)
01: Forcible setting input data
10: Forcible setting validity information
11: Non-forcible-setting-target data

In the cases illustrated in FIGS. 21A and 21B, the target variable is a variable for which the forcible setting can be performed. It is assumed that whether or not the target variable is a variable for which the forcible setting can be performed is reported from the PC 2 to the PLC 1 by the forcible setting availability identifier in the collection target setting information 53 illustrated in FIG. 9. When the target variable is a variable for which the forcible setting can be performed, the address of the input/output memory area, the address of the forcible setting input/output area, and the address of the forcible setting validity information area illustrated in FIG. 10 are reported from the PC 2 to the PLC 1 as the memory addresses in the collection target setting information 53 illustrated in FIG. 9. In this example, the “address 001”, the “address 002”, and the “address 003” are reported as the address of the input/output memory area, the address of the forcible setting input/output area, and the address of the forcible setting validity information area. “00001111” is stored in the address 002 as the forcible setting data of the target variable.

In the case illustrated in FIG. 21A, a value of the actual input data falls within a predetermined range, and the forcible setting is not performed. In this case, the forcible setting validity information stored in the address 003 is “00000000 (invalid)”.

The logging process S250 collects data/information from the memory address reported from the PC 2. That is, the logging process S250 collects the actual input data, the forcible setting data, and the forcible setting validity information from the addresses 001, 002, and 003, respectively. Then, the logging process S250 stores the collected data/information in the ring buffer 62 in association with the collection time. At this time, the data/information identifier is assigned to each piece of data/information. Specifically, “00” is assigned to the actual input data, “01” is assigned to the forcible setting data, and “10” is assigned to the forcible setting validity information.

In this case, the actual input data is given to a corresponding variable in the program execution process S220. Then, the program execution process S220 performs an arithmetic operation using the actual input data and outputs the processing result.

In the case illustrated in FIG. 21B, the value of the actual input data is out of the predetermined range, and the forcible setting is performed. In this case, the forcible setting validity information stored in the address 003 is “11111111 (valid)”.

Similarly to the case illustrated in FIG. 21A, the logging process S250 collects the actual input data, the forcible setting data, and the forcible setting validity information from the addresses 001, 002, and 003, respectively, and stores the collected data in the ring buffer 62. Similarly to the case illustrated in FIG. 21A, the data/information identifier is assigned to each piece of data/information.

In this case, the forcible setting data is given to a corresponding variable in the program execution process S220. Then, the program execution process S220 executes an arithmetic operation using the forcible setting data and outputs the processing result.

In the case illustrated in FIG. 22, the target variable is a variable for which the forcible setting cannot be performed. When the target variable is a variable for which the forcible setting cannot be performed, only the address of the input/output memory area illustrated in FIG. 10 is reported from the PC 2 to the PLC 1 as the memory address in the collection target setting information 53 illustrated in FIG. 9. In this example, an “address 011” is reported as the address of the input/output memory area.

The logging process S250 collects data/information from the memory address reported from the PC 2. That is, the logging process S250 collects the actual input data from the address 011. Then, the logging process S250 stores the collected data in the ring buffer 62 in association with the collection time. At this time, the data/information identifier is assigned to the collected actual input data. However, in the case illustrated in FIG. 22, the forcible setting is not performed for the variable. That is, the actual input data is the non-forcible-setting-target data. Therefore, a value of the data/information identifier is “11”.

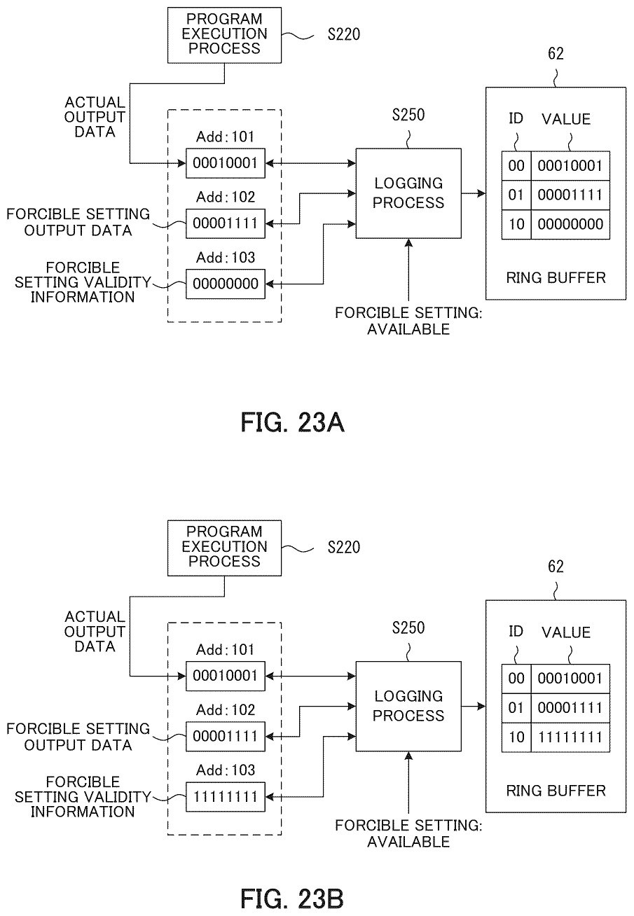

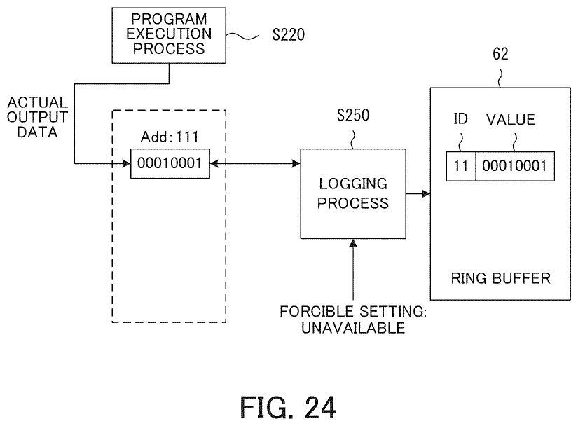

Although FIGS. 21A to 22 illustrate a case where the forcible setting is performed for a variable to which the input data is given, the embodiment of the present invention is also applied to a variable for generating the control data as illustrated in FIGS. 23A to 24.

FIG. 23A illustrates a case where the target variable is a variable for which the forcible setting can be performed, and a value of the actual output data output from the program execution process S220 is within a normal range. FIG. 23B illustrates a case where the target variable is a variable for which the forcible setting can be performed, and the value of the actual output data output from the program execution process S220 is out of the normal range. FIG. 24 illustrates a case where the target variable is a variable for which the forcible setting cannot be performed.

As described above, for a variable for which the forcible setting can be performed, the forcible setting reflected data (actual input data or actual output data), the forcible setting data (forcible setting input data or forcible setting output data), and the forcible setting validity information are collected and stored in association with the collection time in the logging process. At this time, the data/information identifier is assigned to each piece of data/information.

### <Display of Data Collected by Logging Process>

As described above, the logging process is performed by the PLC 1 in the PLC system 10 illustrated in FIG. 1. As a result, the sampled data 73 including the collected value of the variable is stored in the external storage device 17. Hereinafter, a method for displaying the sampled data 73 will be described.

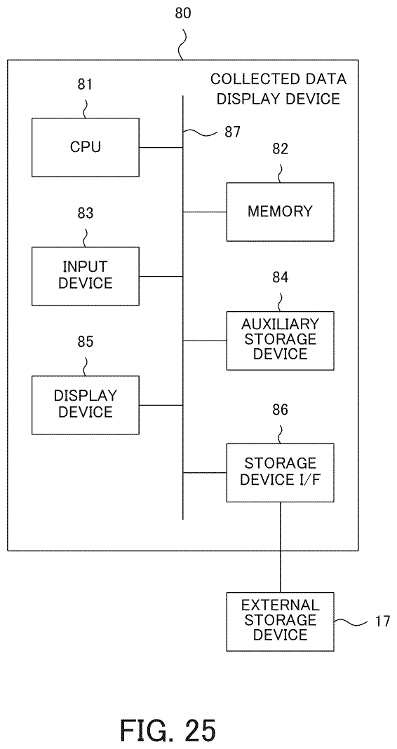

FIG. 25 illustrates an example of a hardware configuration of a collected data display device. A collected data display device 80 includes a CPU 81, a memory 82, an input device 83, an auxiliary storage device 84, a display device 85, and a storage device I/F 86. All of these components are hardware and can transmit data to each other by using an internal bus 87.

The CPU 81 executes a program by using the memory 82 to provide a function of displaying the sampled data 73, a function of processing the sampled data 73 to display a graph or a waveform, and the like. The input device 83 is, for example, a keyboard and/or a pointing device, and is used for input of an instruction or information from the user. The auxiliary storage device 84 is implemented by, for example, a magnetic disk device, an optical disk device, a magneto-optical disk device, a hard disk drive, or a flash memory. The collected data display device 80 can store programs and data in the auxiliary storage device 84 and load and use the programs and data on the memory 82.

The display device 85 displays an inquiry to the user, an instruction to the user, and a processing result, for example. The storage device I/F 86 manages a process of reading various types of data from the external storage device 17 such as a memory card.

Since the hardware configuration illustrated in FIG. 25 is a standard configuration of a general computer, the collected data display device 80 may be implemented using a general computer. In the PLC system 10 of FIG. 1, the collected data display device 80 may be implemented using the PC 2 operating as the support device 30.

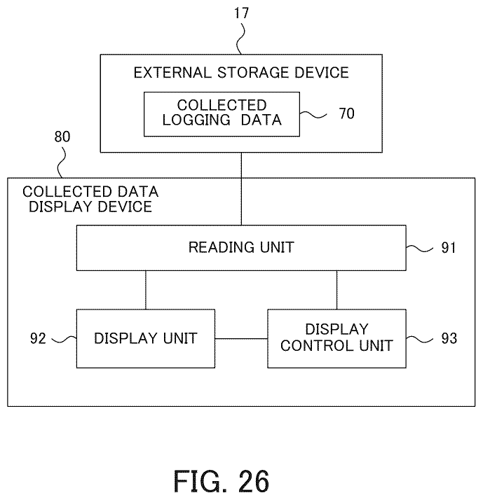

FIG. 26 illustrates an example of a functional configuration of the collected data display device 80. It is assumed that the collected logging data 70 described above is stored in the external storage device 17 by the PLC 1. Further, in the collected logging data 70, the sampled data 73 including the value collected by the logging process is arranged in order of the collection time for each target variable as described with reference to FIGS. 14 to 15B. As illustrated in FIGS. 15A, the sampled data 73 includes the timestamp 74 and the variable data 75 (the data/information identifier 76, the data size 77, and the sampled value 78).

The collected data display device 80 includes a reading unit 91, a display unit 92, and a display control unit 93. The reading unit 91 reads the collected logging data 70 from the external storage device 17. The display unit 92 displays the collection time and the value of the target variable collected at the collection time in association with each other based on the collected logging data 70. The display control unit 93 generates display data for the target variable based on the collected logging data 70. In addition, when a trace of the forcible setting is found in the collected logging data 70, the display control unit 93 generates highlighting data for highlighting the value of the target variable for which the forcible setting has been performed. The display unit 92 can highlight the value of the target variable for which the forcible setting has been performed according to the highlighting data.

With such highlighting, the user can recognize that the forcible setting has been performed for the variable as a logging target. For example, the display control unit 93 can find the trace of the forcible setting based on the value of the forcible setting validity information in the collected logging data 70. In the case illustrated in FIG. 21A, the forcible setting validity information is “00000000”, and thus, it is determined that the forcible setting has not been performed. On the other hand, in the case illustrated in FIG. 21B, the forcible setting validity information is “11111111”, and thus, it is determined that the forcible setting has been performed. At this time, the display control unit 93 can acquire the forcible setting validity information by extracting data/information whose value of the data/information identifier is “10”.

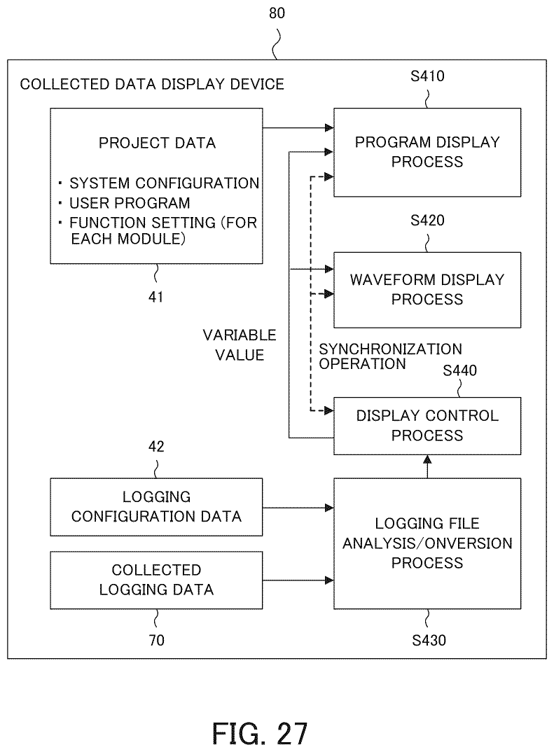

FIG. 27 illustrates an example of a method for displaying the collected logging data 70. The collected data display device 80 executes a program display process S410, a waveform display process S420, a logging file analysis/conversion process S430, and a display control process S440. A program for causing the CPU 81 to execute such steps of process may be referred to as engineering software.

The program display process S410 displays the user program included in the project data 41 described above, and displays the value of the target variable in the user program by using the sampled data 73 included in the collected logging data 70. The project data 41 is already created by the user using a predetermined editing program in the PC 2, and is stored in the auxiliary storage device 84, for example.

The waveform display process S420 displays a relationship between the collection time and the value of the target variable by using a waveform or a graph based on the sampled data 73 included in the collected logging data 70.

The logging file analysis/conversion process S430 analyzes the logging configuration data 42 and the collected logging data 70, and converts the sampled data 73 into input data formats of the program display process S410 and the waveform display process S420. In this example, the logging configuration data 42 and the collected logging data 70 are provided from the external storage device 17. That is, in the logging file analysis/conversion process S430, these pieces of data are read from the external storage device 17 and used.

The display control process S440 includes a process of providing the value of the target variable associated with the collection time obtained by the logging file analysis/conversion process S430 to the program display process S410 and the waveform display process S420. In addition, the display control process S440 includes a process of synchronizing the display by the program display process S410 and the display by the waveform display process S420.

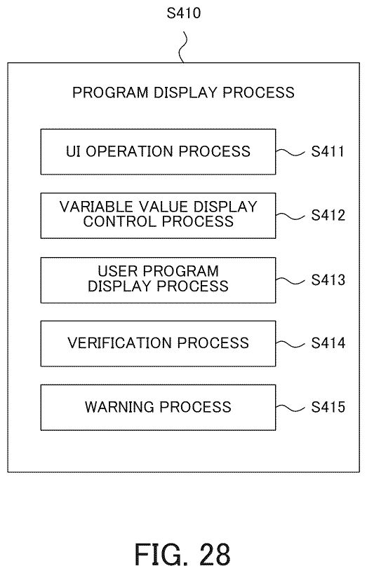

FIG. 28 illustrates an example of the program display process S410. The program display process S410 includes a UI operation process S411, a variable value display control process S412, a user program display process S413, a verification process S414, and a warning process S415.

The UI operation process S411 receives information corresponding to an operation on the input device 83 by the user of the collected data display device 80. The variable value display control process S412 controls the display of the value of the target variable according to the information received by the UI operation process S411 and synchronization information from the display control process S440. The user program display process S413 displays the user program included in the project data 41 and displays the value of the target variable under the control of the variable value display control process S412.

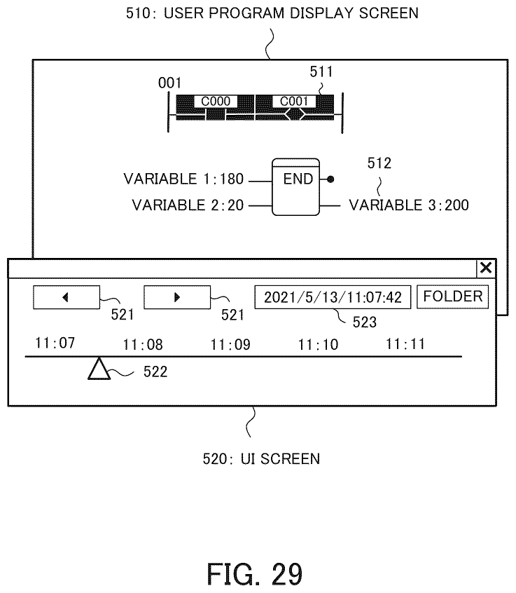

FIG. 29 illustrates an example of a sampled data display screen of the collected data display device 80. The display screen is displayed on the display device 85 when the CPU 81 executes the program display process S410. In the screen example, a UI screen 520 generated by the UI operation process S411 is displayed while being superimposed on a user program display screen 510 generated by the program display process S410. In addition, by the program display process S410, a diagram (for example, a ladder program) representing contents of the user program included in the project data 41 is created and displayed as the user program display screen 510.

The UI screen 520 includes a frame advance button 521, a seek bar 522, and a time input field 523. The frame advance button 521 and the seek bar 522 give an instruction to sequentially update the display of the value of the target variable collected at each collection timing. The time input field 523 accepts a time of the collection timing at which the value of the target variable is to be displayed. The time input field 523 also has a function of displaying the time of the collection timing designated using the frame advance button 521 or the seek bar 522.

When the collection timing designated using the frame advance button 521 or the seek bar 522 is detected by the UI operation process S411, the time representing this timing is displayed in the time input field 523. When the user designates the time by using the time input field 523, the UI operation process S411 specifies the collection timing at which the value of the target variable is to be displayed.

The variable value display control process S412 acquires the value of the target variable with which the collection timing is associated in the collected logging data 70 and information indicating the designated collection timing (that is, the collection timing at which the value of the target variable is to be displayed). Here, the collected logging data 70 is acquired by the logging file analysis/conversion process S430 and passed to the display control process S440. Then, the variable value display control process S412 acquires the collected logging data 70 from the display control process S440. In addition, the variable value display control process S412 sends the value of the target variable at the designated collection timing to the program display process S410. Then, the program display process S410 displays the value of the target variable at the designated collection timing on the user program display screen 510.

As illustrated in FIG. 29, the user program display screen 510 includes an ON/OFF indicator 511 and a variable indicator 512. In a case where a state of a program component representing an ON state or an OFF state is selected as the target variable, the ON/OFF indicator 511 displays the variable value by performing display in which the element is filled with a color corresponding to the state represented by the value of the variable. In this screen example, as the ON/OFF indicator 511, a collection target element in the user program is displayed in black. However, actually, for example, in the case of “ON”, the collection target element is displayed in red, and in the case of “OFF”, the collection target element is displayed in blue.

In a case where a numerical value related to the program component is selected as the target variable, the variable indicator 512 displays the numerical value as the variable value.

In this manner, the collection time and the value of the target variable collected at the collection time are associated with each other and displayed on the display device 85 by the program display process S410.

The verification process S414 collates the project data 41, the project data information 51 in the logging configuration data 42, and the project data information 51 in the collected logging data 70. In addition, the warning process S415 outputs a predetermined warning when the project data 41 and the project data information 51 do not match each other in the verification process S414.

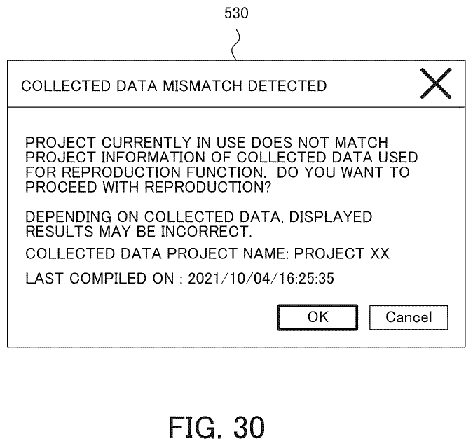

FIG. 30 illustrates an example of a warning screen displayed on the display device 85. The warning by the warning process S415 is implemented, for example, by displaying the warning screen as illustrated in FIG. 30 on the display device 85. The warning screen includes a warning dialog 530 for notifying the user that the project data 41 and the project data information 51 do not match each other. Since it is useful when debugging of the user program is performed, the value of the target variable is displayed in the collected data display device 80 even when the warning is output.

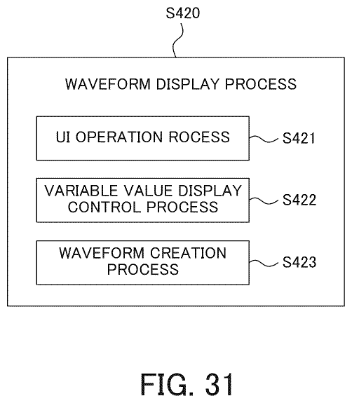

FIG. 31 illustrates an example of the waveform display process S420. As illustrated in FIG. 31, the waveform display process S420 includes a UI operation process S421, a variable value display control process S422, and a waveform creation process S423.

The UI operation process S421 is substantially the same as the UI operation process S411, and receives the information corresponding to the operation on the input device 83 by the user of the collected data display device 80. The variable value display control process S422 is substantially the same as the variable value display control process S412, and controls the display of the value of the target variable according to the information received by the UI operation process S421 and the synchronization information from the display control process S440. The waveform creation process S423 creates and displays the waveform or the graph representing the relationship between the collection timing and the target variable based on the value of the target variable with which the collection timing is associated, provided by the display control process S440.

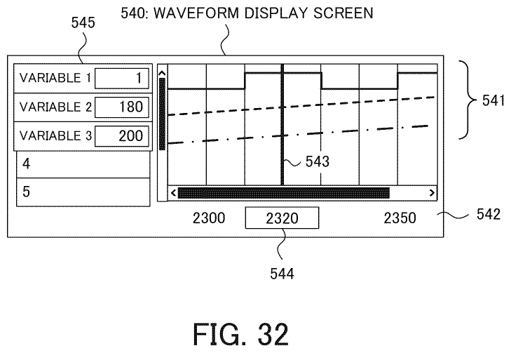

FIG. 32 illustrates an example of a waveform display screen for the sampled data. A waveform display screen 540 is displayed on the display device 85 when the CPU 81 executes the waveform display process S420.

Waveforms 541 displayed on the waveform display screen 540 are created by the waveform display process S420. In the screen example illustrated in FIG. 32, the waveforms 541 corresponding to “Variable 1”, “Variable 2”, and “Variable 3” are represented by a solid line, a broken line, and a line with alternating long and short dashes, respectively. In addition, a time display area 542 is set for the waveforms 541 and represents a time at which the variable value is collected.

When the UI operation process S421 receives an instruction to change a collection time range, the waveform display process S420 displays the waveform 541 in the instructed collection time range on the waveform display screen 540. The collection time range is designated by the user using the UI screen 520 illustrated in FIG. 29, for example. In addition, a time (23:20 in FIG. 32) corresponding to a collection timing identified by a thick line 543 is displayed in a time display field 544 by the waveform display process S420. The thick line 543 is set, for example, by the user designating the time.

The variable value display control process S422 acquires the value of the target variable with which the collection timing is associated in the collected logging data 70. In addition, the variable value display control process S422 recognizes the time corresponding to the collection timing displayed in the time display field 544. Then, the variable value display control process S422 displays a value corresponding to a position of an intersection between the waveform 541 and the thick line 543 in a variable value display field 545 as the value of the target variable at the time designated by the user. For example, a value “200” of Variable 3 at 23:20 is displayed.

As described above, the collected data display device 80 can display a change in the value of each target variable with respect to time by using the waveform or the graph by executing the waveform display process S420.

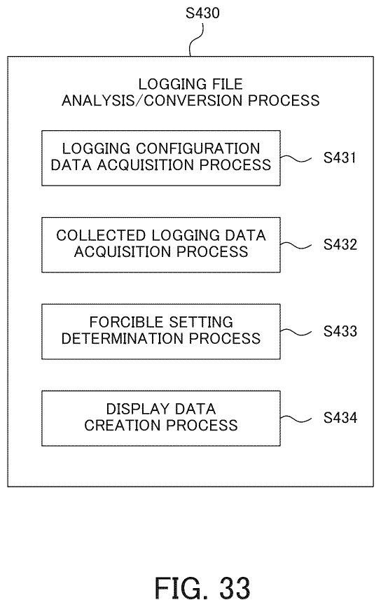

FIG. 33 illustrates an example of the logging file analysis/conversion process S430. The logging file analysis/conversion process S430 includes a logging configuration data acquisition process S431, a collected logging data acquisition process S432, a forcible setting determination process S433, and a display data creation process S434.

The logging configuration data acquisition process S431 acquires the logging configuration data 42 from the external storage device 17. The collected logging data acquisition process S432 acquires the collected logging data 70 from the external storage device 17. The collected logging data acquisition process S432 provides the function of the reading unit 91 illustrated in FIG. 26.

The forcible setting determination process S433 searches for the trace of the forcible setting for the target variable in the collected logging data 70. The trace of the forcible setting is indicated by, for example, the forcible setting validity information. In this case, the forcible setting determination process S433 acquires the forcible setting validity information by searching the collected logging data 70 for the data/information identifier. Then, the forcible setting determination process S433 determines whether or not the forcible setting has been performed for the target variable based on the value of the forcible setting validity information. For example, in the cases illustrated in FIGS. 21A to 24, if the forcible setting validity information is “00000000”, it is determined that the forcible setting has not been performed for the variable data, and if the forcible setting validity information is “11111111”, it is determined that the forcible setting has been performed for the variable data.

In a case where the forcible setting determination process S433 determines that the forcible setting has been performed for the target variable, the display data creation process S434 creates the highlighting data indicating that the value of the target variable is a forcibly set value.

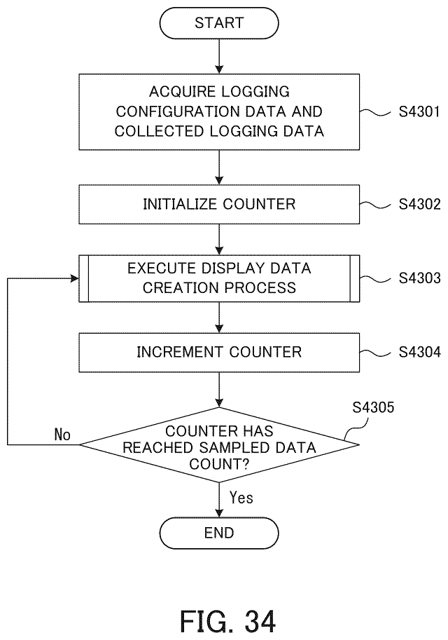

FIG. 34 is a flowchart illustrating an example of the logging file analysis/conversion process S430. Processing in this flowchart is executed by the reading unit 91 and the display control unit 93 of the collected data display device 80 illustrated in FIG. 26.

In S4301, the reading unit 91 acquires the logging configuration data 42 and the collected logging data 70 from the external storage device 17. As illustrated in FIG. 14, the collected logging data 70 includes the sampled data 73 corresponding to each of the plurality of target variables. As illustrated in FIG. 15A, the sampled data 73 corresponding to each target variable includes the variable data 75. As illustrated in FIG. 15B, the variable data 75 corresponding to each target variable includes the sampled value 78 related to the target variable and the data/information identifier 76 of the sampled value 78. When the target variable is a variable for which the forcible setting can be performed, the sampled value 78 is actual data collected by the logging process, the forcible setting data, and the forcible setting validity information.

In S4302, the display control unit 93 initializes a counter. A count value of the counter identifies the plurality of target variables. In S4303, the display control unit 93 selects a target variable corresponding to the count value of the counter from the collected logging data 70, and creates display data of the target variable.

In S4304 and S4305, the display control unit 93 increments the counter. Here, if the count value of the counter has not reached the sampled data count (that is, the number of target variables), the process in the display control unit 93 returns to S4303. That is, the process of S4303 is executed for the next target variable. Then, when the process of S4303 is executed for all the target variables, the process in the display control unit 93 ends. In this manner, the display control unit 93 creates the display data of each target variable.

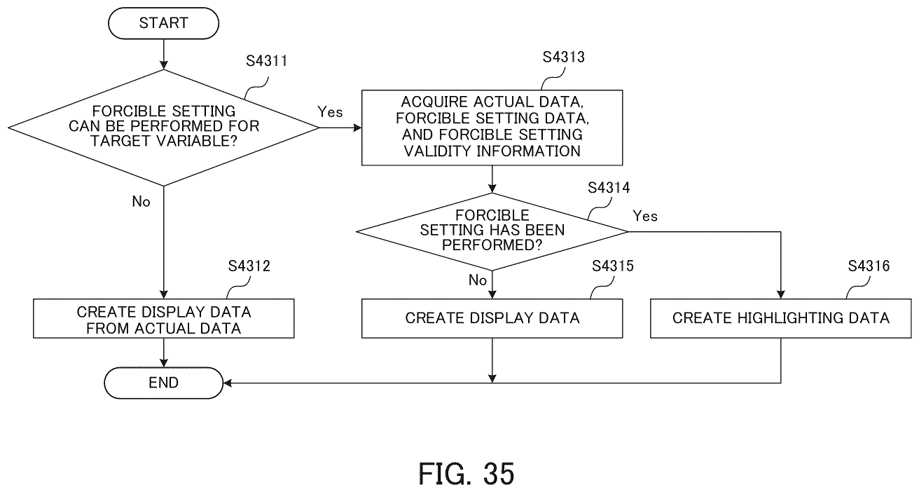

FIG. 35 is a flowchart illustrating an example of a process of creating the display data of each target variable. This process corresponds to S4303 illustrated in FIG. 34.

In S4311, the display control unit 93 determines whether or not the target variable is a variable for which the forcible setting can be performed. Here, if the data/information identifier assigned to the collected data corresponding to the target variable indicates the “non-forcible-setting-target data”, it is determined that the target variable is a variable for which the forcible setting cannot be performed. In this case, in S4312, the display control unit 93 creates normal display data from the actual data (actual input data or actual output data).

When the target variable is a variable for which the forcible setting can be performed, the display control unit 93 acquires the actual data, the forcible setting data, and the forcible setting validity information from the input/output memory area 1011, the forcible setting input/output area 1021, and the forcible setting validity information area 1022 illustrated in FIG. 10 in S4313. Subsequently, in S4314, the display control unit 93 determines whether or not the forcible setting has been performed for the target variable based on the acquired forcible setting validity information.

When the forcible setting has not been performed for the target variable, in S4315, the display control unit 93 calculates the variable value from the actual data, the forcible setting data, and the forcible setting validity information by the method illustrated in FIGS. 19 and 20, and creates the display data for displaying the variable value. The display control unit 93 may obtain the variable value by selecting the actual data instead of calculating the variable value from the actual data, the forcible setting data, and the forcible setting validity information.

When the forcible setting has been performed for the target variable, in S4316, the display control unit 93 calculates the variable value from the actual data, the forcible setting data, and the forcible setting validity information by the method illustrated in FIGS. 19 and 20, and creates the highlighting data for highlighting the variable value. The display control unit 93 may obtain the variable value by selecting the forcible setting data instead of calculating the variable value from the actual data, the forcible setting data, and the forcible setting validity information.

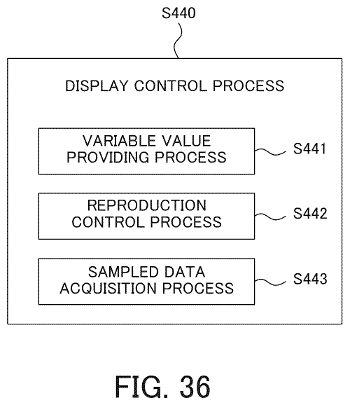

FIG. 36 illustrates an example of the display control process S440. The display control process S440 includes a variable value providing process S441, a reproduction control process S442, and a sampled data acquisition process S443.

The variable value providing process S441 provides the collected logging data 70 obtained by the logging file analysis/conversion process S430 to the program display process S410 and the waveform display process S420 as the value of the target variable with which the collection timing is associated. The provided collected logging data 70 may include the highlighting data created by the logging file analysis/conversion process S430.

When an instruction to synchronize the display screens is received, the reproduction control process S442 controls the program display process S410 and the waveform display process S420 to synchronize contents of the user program display screen 510 and the waveform display screen 540. Furthermore, the reproduction control process S442 includes a process of matching the collection timing designated using the UI screen 520 illustrated in FIG. 29 with the time indicated by the thick line 543 on the waveform display screen 540 illustrated in FIG. 32.

The sampled data acquisition process S443 acquires the collected logging data 70 from the logging file analysis/conversion process S430 and provides the acquired collected logging data 70 to the variable value providing process S441.

In this manner, the collected logging data 70 obtained by the logging file analysis/conversion process S430 is provided to the program display process S410 and the waveform display process S420. At this time, in the collected logging data 70, the highlighting data is created for the target variable for which the forcible setting has been performed. Therefore, the target variable for which the forcible setting has been performed is displayed in a highlighted manner on the user program display screen 510 and/or the waveform display screen 540.

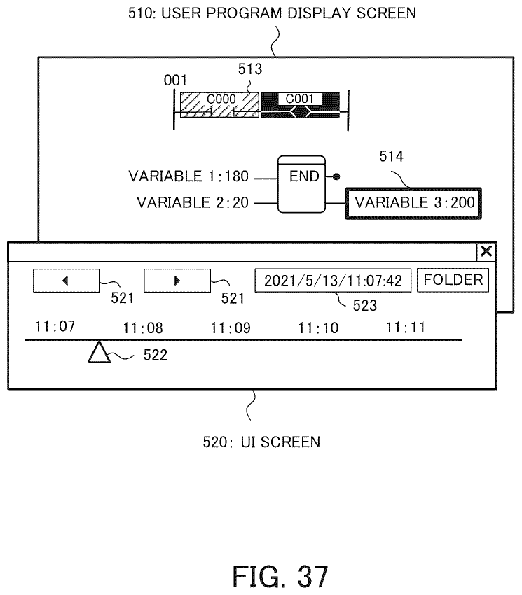

FIG. 37 illustrates an example in which the target variable for which the forcible setting has been performed is highlighted on the user program display screen 510. In this example, it is assumed that the forcible setting has been performed for Variable 3.

In the screen example illustrated in FIG. 37, a single-color program component is included in the user program display screen 510 as a highlighted ON/OFF indicator 513. The highlighted ON/OFF indicator 513 indicates that a state of the program component whose state is the ON state or the OFF state is selected as the target variable and the value of the target variable is forcibly set.

The user program display screen 510 in FIG. 37 includes a highlighted variable indicator 514 that displays Variable 3 in a highlighted manner. The highlighted variable indicator 514 may display a numerical value related to “Variable 3” in a color different from other variables. Alternatively, the highlighted variable indicator 514 may display the numerical value related to “Variable 3” in a different form (for example, bold) from other variables. The highlighted variable indicator 514 indicates that the numerical value related to the program component is selected as the target variable, and the value of the target variable is forcibly set.

As illustrated in FIG. 15A, in the collected logging data 70, the timestamp 74 is added to the variable data 75. Therefore, it is possible to detect a time or period when the forcible setting has been performed for each target variable by analyzing the collected logging data 70. Furthermore, the user can designate the collection time by using the UI screen 520. Then, when the forcible setting has been performed for a certain target variable (here, Variable 3) at the collection time designated by the user, the collected data display device 80 may highlight the target variable.

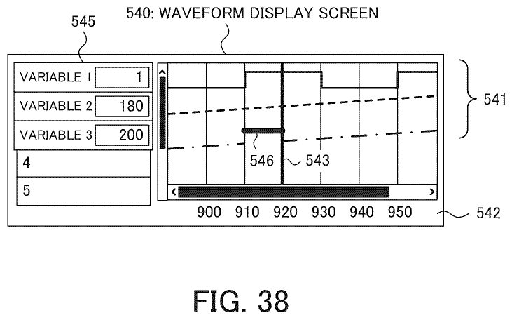

FIG. 38 illustrates an example in which the target variable for which the forcible setting has been performed is highlighted on the waveform display screen 540. In this example, it is assumed that the forcible setting has been performed for Variable 3.

In the screen example illustrated in FIG. 38, the waveform 541 for Variable 3 is highlighted. A highlighted waveform indicator 546 indicates that the forcible setting has been performed for Variable 3. In addition, the highlighted waveform indicator 546 may represent a period during which the forcible setting has been performed. In the screen example illustrated in FIG. 38, the highlighted waveform indicator 546 indicates that the forcible setting has been performed for Variable 3 between 9:10 and 9:20.

In this manner, the functions of the display unit 92 illustrated in FIG. 26 are provided by the program display process S410 and the waveform display process S420. In addition, the functions of the display control unit 93 illustrated in FIG. 26 are provided by the logging file analysis/conversion process S430 and the display control process S440. As a result, when displaying the value of the target variable collected by the logging process, the collected data display device 80 displays the target variable (or the variable value of the target variable) for which the forcible setting has been performed in a highlighted manner. Therefore, the user can easily identify whether the value acquired from the user program of the PLC 1 is a value output from the instrument or a predetermined value forcibly set.

In a case where the user of the PLC system 10 determines whether or not to perform the forcible setting, the user recognizes for which variable the forcible setting has been performed. On the other hand, log data collected by the logging process is referred to, for example, when some kind of failure occurs in the PLC system 10. At this time, a user who refers to the log data may be different from the user who has determined to perform the forcible setting. In maintenance or troubleshooting of the PLC system 10, log data after several days or weeks may be referred to. In these cases, the user who refers to the log data may not recognize when and for which variable the forcible setting has been performed. Therefore, it is useful to highlight the variable for which the forcible setting has been performed based on the embodiment of the present invention even in a case where the user of the PLC system 10 performs the forcible setting.

Although the embodiment of the disclosure and advantages thereof have been described in detail above, those skilled in the art will be able to make various changes, additions, and omissions without departing from the scope of the present invention clearly described in the claims.

What is claimed is:

1. A programmable logic controller for controlling an external apparatus, the programmable logic controller comprising:
an execution unit configured to repeatedly execute a control processing cycle, during which the execution unit performs
a program execution process of executing a control program for controlling the external apparatus, the control program including a variable,
an output process of outputting an execution result of the control program, and
a logging process of collecting variable data related to the variable in the control program according to a logging configuration;
a memory that includes
a first memory area configured to store actual input data to be given to the variable, and
a second memory area configured to store control information related to forcible setting, during which forcible setting input data instead of the actual input data is provided to the variable; and
a storage unit that stores the variable data collected by the logging process,
wherein the execution unit is configured to
generate input data to be given to the variable based on the actual input data and the control information, and
store the actual input data and the control information in the storage unit in association with a time at which the variable data is collected in the logging process.

2. The programmable logic controller according to claim 1, wherein
the control information includes:
the forcible setting input data, and
forcible setting validity information indicating whether or not the forcible setting has been performed, and
the execution unit is further configured to store the actual input data, the forcible setting input data, and the forcible setting validity information in the storage unit in association with the time in the logging process.

3. The programmable logic controller according to claim 2, wherein
when the forcible setting has not been performed, the execution unit provides, as the input data, the actual input data to the variable, and
when the forcible setting has been performed, the execution unit provides, as the input data, the forcible setting input data to the variable.

4. The programmable logic controller according to claim 1, wherein
the control program further includes a second variable;
the memory further includes:
a third memory area configured to store actual output data calculated using the second variable in the control program, and
a fourth memory area configured to store second control information related to second forcible setting for outputting forcible setting output data instead of the actual output data to the external apparatus; and
the execution unit is further configured to:
generate output data to be provided to the external apparatus based on the actual output data and the second control information, and
store the actual output data and the second control information in the storage unit in association with the time at which the variable data is collected in the logging process.

5. A support device that supports a programmable logic controller, the programmable logic controller including
an execution unit that repeatedly executes a control processing cycle, during which the execution unit performs
a program execution process of executing a control program for controlling the external apparatus, the control program including a variable,
an output process of outputting an execution result of the control program, and
a logging process of collecting variable data related to the variable in the control program according to a logging configuration, and
a memory that includes
a first memory area configured to store actual input data to be given to the variable, and
a second memory area configured to store control information related to forcible setting, during which forcible setting input data instead of the actual input data is provided to the variable, wherein
the execution unit is configured to store the actual input data and the control information in a storage unit in association with a time at which the variable data is collected in the logging process,
the support device comprising:
a setting information output unit configured to generate and output the logging configuration, which includes information indicating that the actual input data stored in the first memory area and the control information stored in the second memory area are collected in the logging process.

6. A display device that displays data collected by a programmable logic controller, the programmable logic controller including
an execution unit that repeatedly executes a control processing cycle, during which the execution unit performs
a program execution process of executing a control program for controlling the external apparatus, the control program including a variable,
an output process of outputting an execution result of the control program, and
a logging process of collecting variable data related to the variable in the control program according to a logging configuration, and
a memory that includes
a first memory area configured to store actual input data to be given to the variable, and
a second memory area configured to store control information related to forcible setting, during which forcible setting input data instead of the actual input data is provided to the variable, wherein
the execution unit is configured to store the actual input data and the control information in a storage device in association with a time at which the variable data is collected as collected logging data in the logging process,
the display device comprising:
a reading unit that reads the collected logging data from the storage device;
an analysis unit that determines whether or not the forcible setting has been performed for the variable based on the control information; and
a display unit that displays a value represented by the actual input data when the forcible setting has not been performed for the variable, and displays a value represented by the forcible setting input data when the forcible setting has been performed for the variable.
